(19) United States
(12) Patent Application Publication
(10) Pub. No.: US 2016/0191322 A1
(43) Pub. Date: Jun. 30, 2016

(54) STORAGE APPARATUS, METHOD OF CONTROLLING STORAGE APPARATUS, AND COMPUTER-READABLE RECORDING MEDIUM HAVING STORED THEREIN STORAGE APPARATUS CONTROL PROGRAM

(71) Applicant: FUJITSU LIMITED, Kawasaki-shi (JP)

(72) Inventors: Joichi Bita, Kahoku (JP); Marie Abe, Kawasaki (JP)

(73) Assignee: FUJITSU LIMITED, Kawasaki-shi (JP)

(21) Appl. No.: 14/940,953

(22) Filed: Nov. 13, 2015

(30) Foreign Application Priority Data
Dec. 24, 2014 (JP) 2014-259640

(51) Int. Cl. H04L 12/24

(52) U.S. Cl. CPC H04L 41/0896

(57) ABSTRACT

A storage apparatus includes a processor, in which the processor determines presence/absence of an input/output request in a standby state for each storage device, determines presence/absence of a bandwidth to spare of the storage apparatus including the storage devices in a case where a first storage device, for which the input/output request that is in the standby state, is determined to be present among the plurality of storage devices, and executes bandwidth accommodation from a first unassigned band of the storage apparatus to the first storage device in a case where the bandwidth to spare is determined to be present in the storage apparatus. Accordingly, a bandwidth to spare of the storage apparatus to which the storage device belongs can be accommodated to a storage device having an insufficient bandwidth.

### CROSS-REFERENCE TO RELATED APPLICATION

This application is based upon and claims the benefit of priority of the prior Japanese Application No. 2014-259640 filed on Dec. 24, 2014 in Japan, the entire contents of which are hereby incorporated by reference.

### FIELD

The embodiment discussed herein is directed to a storage apparatus, a method of controlling a storage apparatus, and a recording medium having stored therein a storage apparatus control program.

### BACKGROUND

In a storage system in which a plurality of servers (hereinafter, referred to as hosts) share one storage apparatus, there are cases where input/output processes requested from the hosts contend inside the storage apparatus, and stable performance is not be maintained for each input/output process (application). Thus, there are cases where a storage apparatus has a quality of service (QoS) function for maintaining appropriate performance according to a priority level for each input/output process by performing the process with priority levels (degree of priority) being assigned to the processing requests from the hosts.

Relating to the QoS function (storage QoS) included in a storage apparatus, a technology for allocating internal resources such as a queue and the like based on a priority level designated by a host and executing a command is known. As an example, a case will be described in which, in a storage system in which two hosts A and B share one storage apparatus, host A transmits a command with a priority level being designated thereto. When the priority level is designated from host A, for example, the storage apparatus allocates internal resources that are three times those allocated to a process to which a priority level is not designated. As a result, the storage apparatus performs an input/output process requested from host A with priority over an input/output process requested from host B.

In addition, a technology for maintaining appropriate performance according to a priority level for each input/output process (application) by setting target performance or a performance limit to each host or logical unit (LU) on the storage apparatus side is known. Hereinafter, the “LU” may be referred to as a “volume”.

Furthermore, a technology for responding to a change in the load status by changing a priority level set for a specific input/output process in a case where the load status of the input/output process changes is known. For example, according to such a technology, in a case where an actual input/output processing amount is continuously below the processing performance (processing bandwidth) of the whole storage within a predetermined time, priority levels set to LUs of which the input/output processing amount arrives at a performance limit (bandwidth limit) and the like are raised by one. By raising the priority levels of the LUs and the like by one, the bandwidth limits of the LUs and the like are changed to be high. Accordingly, the performance of the LU and the like is adjusted, and a change in the load status can be responded.

At this time, a technology for temporarily distributing/accommodating a processing performance (bandwidth) from a LU having a processing performance (bandwidth) to spare to a LU having an insufficient processing bandwidth in a case where the processing bandwidth of the LU is temporarily insufficient is also known.

[Patent Document 1] Japanese Laid-open Patent Publication No. 2006-53601

[Patent Document 2] Japanese Laid-open Patent Publication No. 2009-93636

[Patent Document 3] Japanese Laid-open Patent Publication No. 2013-127758

[Patent Document 4] Japanese Laid-open Patent Publication No. 2003-131814

[Patent Document 5] Japanese Laid-open Patent Publication No. 2001-147886

In a storage apparatus having a QoS function, in a case where the processing bandwidth is accommodated to a LU having an insufficient processing bandwidth, the accommodation is executed only from an LU having a processing bandwidth to spare. For this reason, when there is no LU having a processing bandwidth to spare, and the accommodation of the processing bandwidth to a LU having an insufficient processing bandwidth cannot be executed, even in a case where there is a bandwidth to spare in the entire storage apparatus, a RAID (Redundant Arrays of Inexpensive Disks) group, and disk drives to which a LU belongs, the performance to spare cannot be accommodated to a LU having an insufficient-bandwidth.

### SUMMARY

A storage apparatus according to an embodiment includes a processor, in which the processor determines presence/absence of an input/output request that is in a standby state for each of a plurality of storage devices; determines presence/absence of a bandwidth to spare of the storage apparatus including the plurality of storage devices in a case where a first storage device, for which the input/output request that is in the standby state, is determined to be present among the plurality of storage devices; and executes bandwidth accommodation from a first unassigned band of the storage apparatus to the first storage device in a case where the bandwidth to spare is determined to be present in the storage apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram that illustrates an example of the hardware configuration of a storage system according to this embodiment;

FIG. 2 is a block diagram that illustrates the functional configuration of a processing unit realized by firmware that is executed by a storage apparatus according to this embodiment;

FIG. 3 is a block diagram that illustrates the functional configuration of an SCSI target control unit and information of a QoS control area and a table area according to this embodiment;

FIG. 4 is a diagram that illustrates an example of a correspondence relation between a priority level and a bandwidth value;

FIG. 5 is a diagram that illustrates an example of a QoS management table;

FIG. 6 is a flowchart that illustrates the processing sequence of an N-milli-second timer scheduling process according to this embodiment;

FIG. 7 is a flowchart that illustrates the processing sequence of an all-LU limits adding process according to this embodiment;

FIG. 8 is a flowchart that illustrates the processing sequence of a QoS input/output (I/O) startup scheduling process according to this embodiment;

FIG. 9 is a flowchart that illustrates the processing sequence of the QoS I/O startup scheduling process according to this embodiment;

FIG. 10 is a flowchart that illustrates the processing sequence of a command reception process performed by the storage apparatus according to this embodiment;

FIG. 11 is a flowchart that illustrates the processing sequence of a micro accommodation process according to this embodiment;

FIG. 12 is a flowchart that illustrates the processing sequence of a post-process of micro accommodation according to this embodiment;

FIG. 13 is a flowchart that illustrates the processing sequence of a macro accommodation one-second checking process according to this embodiment;

FIGS. 14 and 15 represent a flowchart that illustrates the processing sequence of a macro accommodation process according to this embodiment;

FIGS. 16 and 17 represent a flowchart that illustrates the processing sequence of a macro accommodation restoration process according to this embodiment;

FIG. 18 is a diagram that illustrates an example of an accommodation destination unit array (LUN/host number array) generated in the macro accommodation restoration process according to this embodiment;

FIGS. 19 and 20 are diagrams that specifically illustrate the macro accommodation restoration process according to this embodiment; and

FIG. 21 is a block diagram that illustrates a computer executing a storage apparatus control program according to this embodiment.

FIG. 22 is a diagram that illustrates an example of an average throughput value (sequential bandwidth value) and an average response time used for calculating the busy rate of a disk drive according to this embodiment for each disk drive type;

FIG. 23 is a diagram that illustrates an example of an average IOPS value (random bandwidth value) and an average response time used for calculating the busy rate of a disk drive according to this embodiment for each disk drive type;

FIG. 24 is a diagram that illustrates an example of a maximum read block number, a maximum write block number, a maximum read command number, and a maximum write command number used for calculating the busy rate of a disk drive according to this embodiment for each disk drive type;

FIG. 25 is a diagram that illustrates an example of a disk drive mixture coefficient used for calculating the busy rate of a RAID group according to this embodiment for each disk drive type;

FIG. 26 is a diagram that illustrates an example of a flexible tiered weighting coefficient used for calculating the busy rate of a RAID group according to this embodiment for each disk drive type;

FIG. 27 is a diagram that illustrates an example of the number of blocks and the number of commands that can be processed within 0.5 seconds by each disk drive for each disk drive type;

FIG. 28 is a diagram that illustrates an example of the number of disk drive I/Os for each RAID level for Volume 1 I/O; and

FIGS. 29 to 31 are flowcharts that illustrate the processing sequence of a micro accommodation process according to this embodiment.

### DESCRIPTION OF THE PREFERRED EMBODIMENTS

Hereinafter, a storage apparatus, a method of controlling a storage apparatus, and a computer-readable recording medium stored therein a storage control program according to an embodiment disclosed herein will be described in detail with reference to the drawings. However, the embodiment represented as below is merely an example, and there is no intention for excluding various modified examples or the application of various technologies that are not explicitly described in the embodiment. In other words, this embodiment may be variously changed in a range not departing from the concept thereof. In addition, each diagram does not represent that only constituent elements illustrated in the diagram are included, but any other function may be included therein. Furthermore, the embodiments may be appropriately combined in a range in which the contents of the processes are not contradictory.

[1] Configuration of this Embodiment

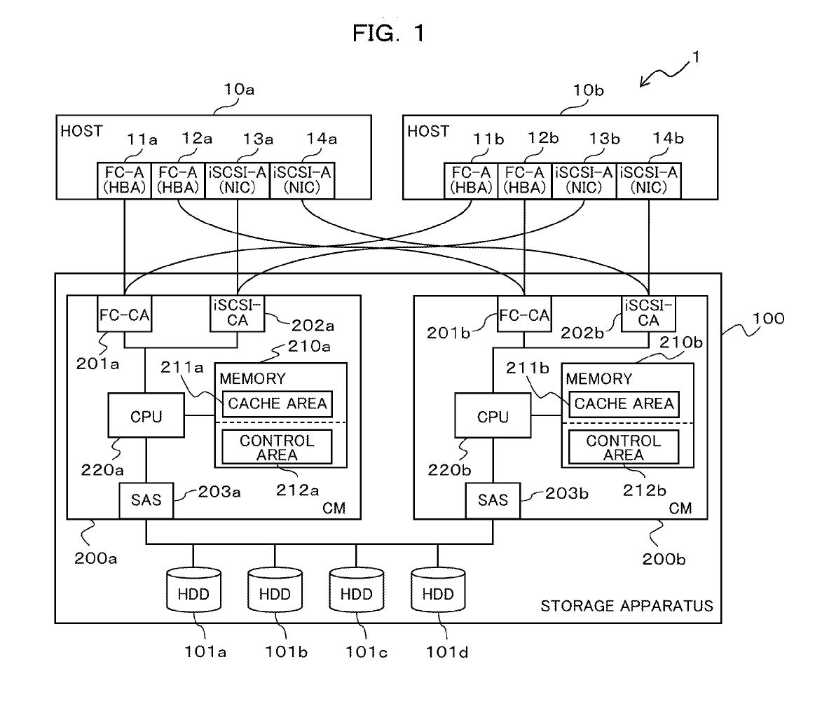

First, the configuration of this embodiment will be described with reference to FIGS. 1 to 5.

[1-1] Configuration of Storage System of this Embodiment

FIG. 1 is a diagram that illustrates an example of the configuration of a storage system 1 according to this embodiment. As illustrated in FIG. 1, the storage system 1 includes a host 10a, a host 10b, and a storage apparatus 100. In the storage system 1, the storage apparatus 100 is connected to the host 10a and the host 10b. Here, the number of hosts connected to the storage apparatus 100 is not limited to that illustrated in the figure but may be changed.

[1-2] Configuration of Host

Subsequently, the configurations of the hosts 10a and 10b will be described with reference to FIG. 1. The hosts 10a and 10b are information processing apparatuses such as servers. The host 10a includes: a fiber channel (FC)—adapter (A) 11a; a FC-A 12a; an Internet Small Computer System Interface (iSCSI)-A 13a; and an iSCSI-A 14a. The FC-A's 11a and 12b are, commonly, have the form of a FC-host bus adapter (HBA). In addition, the iSCSI-A's 13a and 14a, commonly, have the form in which an iSCSI protocol is operated by using a network interface card (NIC).

The FC-A 11a is an interface for connecting to a FC-communication adapter (CA) 201a arranged inside a controller module (CM) 200a to be described later using an FC. In addition, similarly, the FC-A 12a is an interface for connecting to an FC-CA 201b arranged inside a CM 200b using the FC. Furthermore, the iSCSI-A 13a is an interface for connecting to an iSCSI-CA 202a arranged inside a CM 200a to be described later using the iSCSI. Similarly, the iSCSI-A 14a is an interface for connecting to an iSCSI-CA 202b arranged inside a CM 200b to be described later using the iSCSI.

The host 10b includes an FC-A 11b, an FC-A 12b, an iSCSI-A 13b, and an iSCSI-A 14b. The FC-A 11b corresponds to the FC-A 11a, and the FC-A 12b corresponds to the FC-A 12a. In addition, the iSCSI-A 13b corresponds to the iSCSI-A 13a, and the iSCSI-A 14b corresponds to the iSCSI-A 14a. In description presented below, in a case where any one of the hosts 10a and 10b is generally referred to without discriminating the host 10a and the host 10b from each other, it will be represented as a host 10.

[1-3] Configuration of Storage Apparatus According to this Embodiment

Subsequently, the configuration of the storage apparatus 100 according to this embodiment will be described with reference to FIG. 1. The storage apparatus 100 according to this embodiment includes hard disk drives (HDDs) 101a to 101d and CMs 200a and 200b.

The HDDs 101a to 101d configure RAID and store user data. The CMs 200a and 200b are storage control modules that control the entire system of the storage apparatus 100. The CMs 200a and 200b are configured to be redundant. Here, the number of HDDs and the number of CMs included in the storage apparatus 100 are not limited to those illustrated in the figure but may be changed. In addition, the storage system may be configured by mounting a plurality of CMs as storage apparatuses (storage control devices) of a controller enclosure, mounting physical disks such as HDDs in the storage apparatuses of a disk enclosure, and connecting the controller enclosure and the disk enclosure to each other.

In addition, the storage apparatus 100 is used as logical units (hereinafter, referred to as LUs) that are acquired by logically dividing the HDDs 101a to 101d (one or more physical storage devices). Each LU (storage device) is recognized by the hosts 10a and 10b as one logical HDD.

The CM 200a includes an FC-CA 201a, an iSCSI-CA 202a, a serial attached SCSI (SAS) 203a, a memory 210a, and a central processing unit (CPU) 220a.

The FC-CA 201a is an interface connecting to the hosts 10a and 10b using the FC. The iSCSI-CA 202a is an interface connecting to the hosts 10a and 10b using the iSCSI. The SAS 203a is an interface connecting to the HDDs 101a to 101d using the SAS. In description presented below, in a case where the FC-CA 201a and the iSCSI-CA 202a are generally referred to, they will be represented as ports as is appropriate.

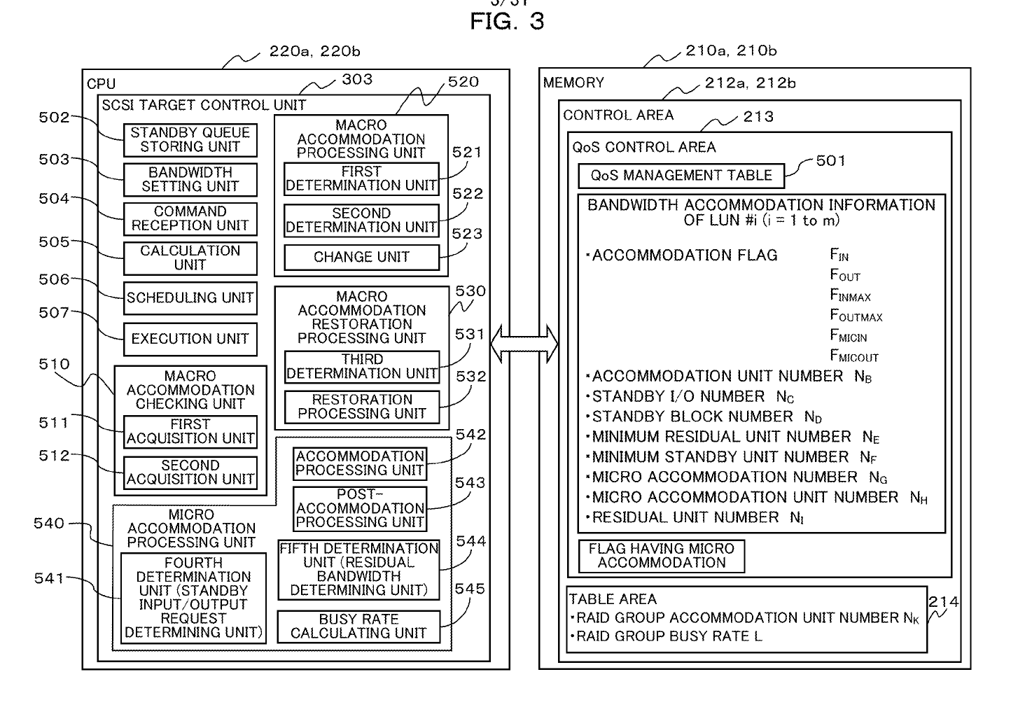

The memory 210a, for example, is a semiconductor memory device such as a random access memory (RAM) and includes a cache area 211a and a control area 212a. The cache area 211a temporarily stores data that is exchanged between the host 10a or 10b and any one of the HDDs 101a to 101d. The control area 212a stores information for various processes performed by the storage apparatus 100. In addition, in the control area 212a, various programs and the like are stored as well. Furthermore, the control area 212a includes a QoS control area 213 (see FIG. 3) to be described later and a table area 214 (see FIG. 3) to be described later.

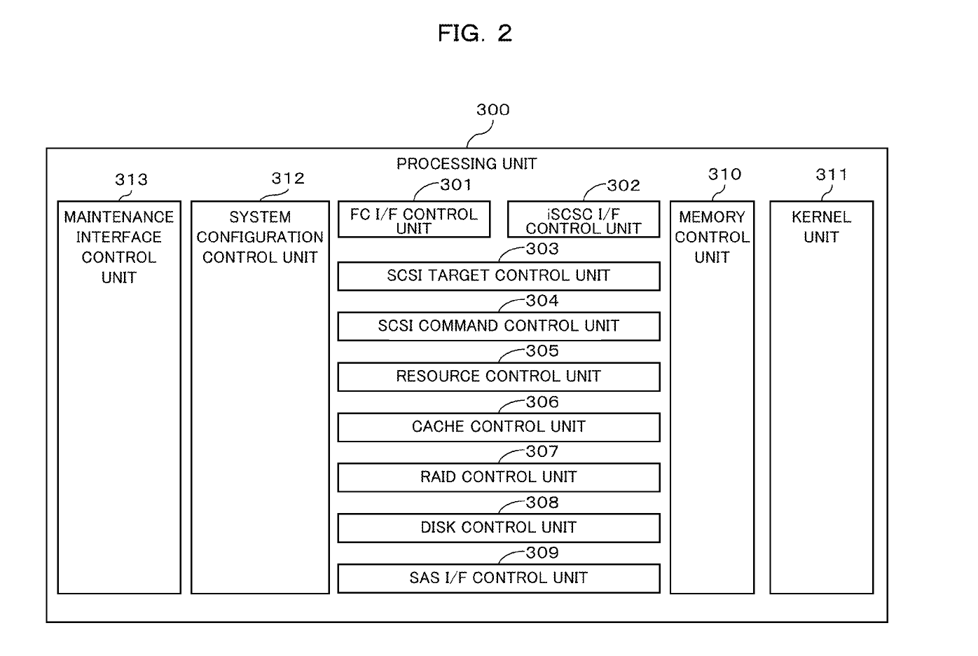

The CPU 220a is an electronic circuit that performs various processes such as calculation processes and control processes and is used for realizing a processing unit 300 (see FIG. 2) to be described later.

The CM 200b includes an FC-CA 201b, an iSCSI-CA 202b, a SAS 203b, a memory 210b, and a CPU 220b. The FC-CA 201b corresponds to the FC-CA 201a, the iSCSI-CA 202b corresponds to the iSCSI-CA 202a, and the SAS 203b corresponds to the SAS 203a. In addition, the memory 210b corresponds to the memory 210a, and the CPU 220b corresponds to the CPU 220a.

In such a storage system 1, the CPUs 220a and 220b of the storage apparatus 100 perform the following process by firmware. The storage apparatus 100 calculates an upper limit of the input/output processing amount that is based on priority levels set in a plurality of LUs for each LU. In addition, the storage apparatus 100 schedules the execution sequence of processes relating to input/output requests based on the processing amounts relating to input/output requests received from the host 10 and the calculated upper limit and performs processes relating to the input/output requests in the scheduled execution sequence. Then, the storage apparatus 100 determines, for each LU, whether or not the processing amount relating to an input/output request for the LU exceeds the processing bandwidth (processing bandwidth) of the LU for a first predetermined time (for example, 30 seconds). In a case where the processing amount relating to the input/output request for the LU is determined to exceed the processing bandwidth of the LU, the storage apparatus 100 changes the upper limit of the LU by a value corresponding to a predetermined unit of bandwidth accommodation (unit). In this way, the storage apparatus 100 controls the storage performance to be optimal in accordance with the status of the input/output request (an I/O request or a command) transmitted from the host 10 and a change in the connection environment of the host 10. Particularly, by changing and adjusting the upper limit by a value corresponding to the predetermined unit of bandwidth accommodation, the storage apparatus 100 can delicately follow a change in the processing bandwidth requested from the host 10 and can respond to various performance changes.

Here, the upper limit of the input/output processing amount, for example, is a limit I/O number or a limit block number to be described later, and the upper limit, the limit I/O number, and the limit block number may be referred to as a limit value or a bandwidth limit value.

[1-4] Functional Configuration of Processing Unit Realized by Firmware

Next, the functional configuration of a processing unit 300 that is realized by firmware executed by the storage apparatus 100 will be described with reference to FIG. 2. FIG. 2 is a block diagram that illustrates the functional configuration of the processing unit 300 realized by firmware that is executed by the storage apparatus 100. The processing unit 300 is realized by the cooperation of the memories 210a and 210b and the CPUs 220a and 220b.

As illustrated in FIG. 2, the processing unit 300 includes an FC interface (I/F) control unit 301, an iSCSI I/F control unit 302, an SCSI target control unit 303, an SCSI command control unit 304, a resource control unit 305, a cache control unit 306, and a RAID control unit 307. In addition, the processing unit 300 includes a disk control unit 308, an SAS I/F control unit 309, a memory control unit 310, a kernel unit 311, a system configuration control unit 312, and a maintenance interface control unit 313.

The FC I/F control unit 301 performs control of an FC protocol chip in a case where the host 10 is connected using the FC. The iSCSI I/F control unit 302 performs control of an iSCSI protocol chip in a case where the host 10 is connected using the iSCSI.

The SCSI target control unit 303 performs control of the SCSI target. The SCSI target control unit 303, for example, performs host management, LU management, command execution management, management of an abnormal system event other than a command, and the like. A detailed function of the SCSI target control unit 303 will be described later with reference to FIG. 3.

The SCSI command control unit 304 performs control for each type of SCSI command. The resource control unit 305 performs logical volume management, host path management, and load management across all the CMs. The cache control unit 306 manages the cache storage device. The RAID control unit 307 manages a RAID group. The disk control unit 308 performs disk command control. The SAS I/F control unit 309 performs control of a protocol chip connecting to the HDDs 101a to 101d using the SAS.

The memory control unit 310 manages a control memory that is used by each control unit. The kernel unit 311 is a basic software part and is placed at a subordinate position of each control unit. The system configuration control unit 312 manages the configuration information of the storage apparatus 100. The maintenance interface control unit 313 controls a user interface for maintenance.

[1-5] Functional Configuration of SCSI Target Control Unit and Information of QoS Control Area According to this Embodiment

Next, the functional configuration of the SCSI target control unit 303 and the information of the QoS control area 213 and the table area 214 will be described with reference to FIG. 3. FIG. 3 is a block diagram that illustrates the functional configuration of the SCSI target control unit 303 and the information of the QoS control area 213 and the table area 214 according to this embodiment.

As illustrated in FIG. 3, the SCSI target control unit 303 performs control based on a QoS management table 501 to be described later, bandwidth accommodation information of each LU (LUN #1 to #m; here, m is an integer of two or more) to be described later, a micro accommodation presence flag to be described later, information of the table area 214 to be described later, and the like. The QoS management table 501, the bandwidth accommodation information of each LU, and the micro accommodation presence flag, for example, are stored in the QoS control areas 213 of the control areas 212a and 212b of the memories 210a and 210b.

As illustrated in FIG. 3, the SCSI target control unit 303 includes: a standby queue storing unit 502; a bandwidth setting unit 503; a command reception unit 504; a calculation unit 505; a scheduling unit 506; and an execution unit 507. In addition, the SCSI target control unit 303 includes: a macro accommodation checking unit 510; a macro accommodation processing unit 520; a macro accommodation restoration processing unit 530; and a micro accommodation processing unit 540. Each function of the SCSI target control unit 303 described below is realized by cooperation of the memories 210a and 210b and the CPUs 220a and 220b.

[1-5-1] Correspondence Relation Between Priority Level and Bandwidth Value and QoS Management Table

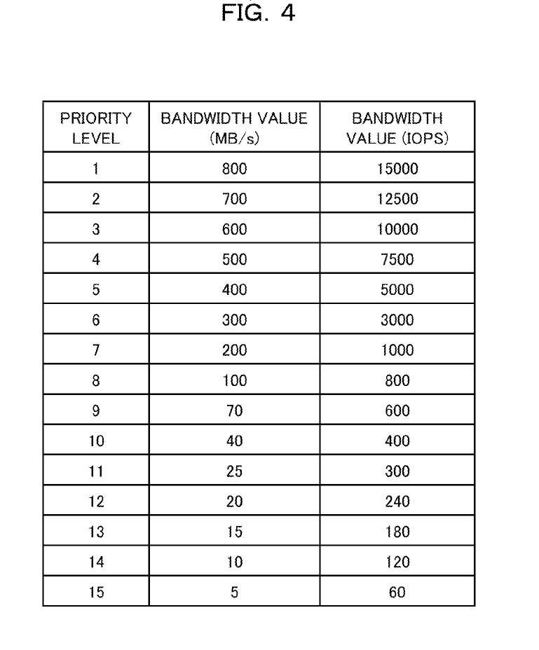

The QoS management table 501, for each target, stores information associated with a “priority level”, “bandwidth values”, “the number of input/output processes that can be executed”, and “the number of executed input/output processes”. Here, before detailed description of the QoS management table 501, first, the correspondence relation between the “priority level” and the “bandwidth values” will be described with reference to FIG. 4. FIG. 4 is a diagram that illustrates an example of the correspondence relation between the priority level and the bandwidth values.

As illustrated in FIG. 4, the “priority level” represents the degree of priority and, for example, is set as levels of 15 ranks of 1 to 15. Here, the levels of the priority level represent merely an example and are not limited to 15 ranks of 1 to 15.

The “bandwidth values” are associated with each rank of the “priority level”. In other words, the “priority level” represents a bandwidth limit. As the “bandwidth values”, megabytes per second (MB/s) that is a communication amount per unit time and input/output per second (IOPS) that is the number of input/output processes that can be executed per unit time are used. Specific “bandwidth values (MB/s and IOPS)” for the “priority level” (bandwidth setting level), for example, are set in consideration of a practical performance as illustrated in FIG. 4.

In the example illustrated in FIG. 4, in a case where the “priority level” is set to “1”, the communication amount per unit time is represented to be “800 (MB/s)”, and “15,000” input/output processes are represented to be executed per unit time. Similarly, in a case where the “priority level” is set to “3”, the communication amount per unit time is represented to be “600 (MB/s)”, and “10,000” input/output processes are represented to be executed per unit time.

In the example illustrated in FIG. 4, the interval of the bandwidth values (MB/s) for the priority levels of 1 to 8 is 100, the interval of the bandwidth values (MB/s) for the priority levels of 8 to 10 is 30, the interval of the bandwidth values (MB/s) for the priority levels of 10 to 11 is 15, and the interval of the bandwidth values (MB/s) for the priority levels of 11 to 15 is 5. In other words, the bandwidth value (MB/s) is set to increase from a low level (15) of the “priority level” toward a high level (1).

Similarly, the interval of the bandwidth values (IOPS) for the priority levels of 1 to 5 is 2,500, the interval of the bandwidth values (IOPS) for the priority levels of 5 to 7 is 2,000, the interval of the bandwidth values (IOPS) for the priority levels of 7 to 10 is 200, the interval of the bandwidth values (IOPS) for the priority levels of 10 to 11 is 100, and the interval of the bandwidth values (IOPS) for the priority levels of 11 to 15 is 60. In other words, the bandwidth value (IOPS) is also set to increase from a low level (15) of the “priority level” toward a high level (1).

In addition, in the table area 214 illustrated in FIG. 3, for each RAID group belonging to the storage apparatus 100, the number N_{K} of units (a RAID group accommodation unit number) accommodated to an accommodation destination LU (a LU of which the accommodation flag F_{IN} to be described later is On) within each RAID group is stored. The RAID group accommodation unit number N_{K} is cleared for every one micro cycle to be described later.

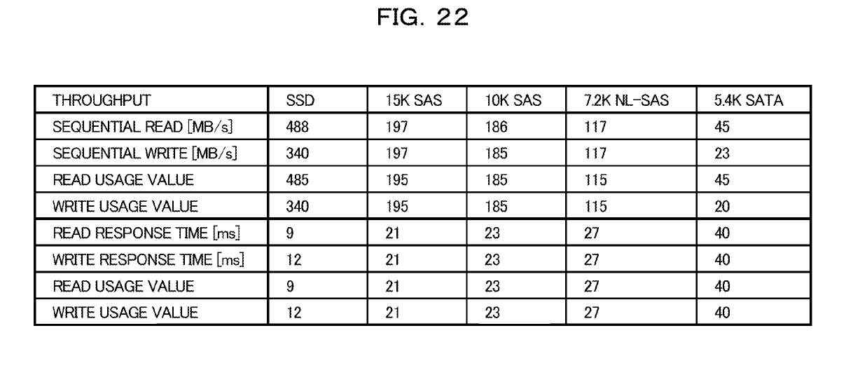

Furthermore, in the table area 214 illustrated in FIG. 3, for each RAID group belonging to the storage apparatus 100, the busy rate (RAID group busy rate) L of each RAID group is stored. The RAID group busy rate L is a value relating to a bandwidth to spare of the entire storage apparatus 100 and is calculated by a busy rate calculating unit 545 to be described later for every predetermined time (for example, N milli-seconds to be described later or N×n seconds: here, n is an integer of two or more). The calculation sequence of the RAID group busy rate L will be described later with reference to FIGS. 22 to 26.

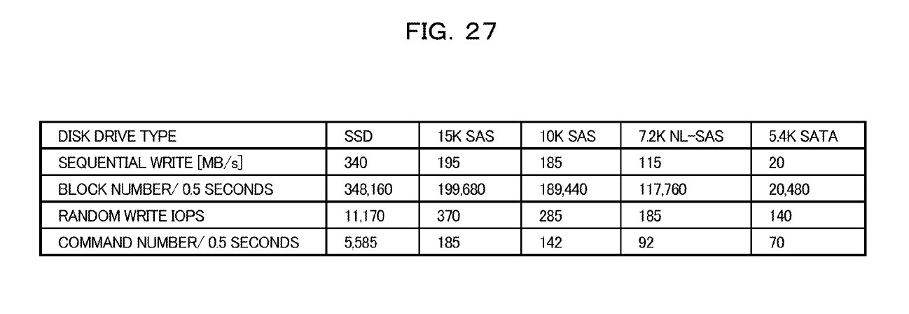

In addition, in a case where bandwidth accommodation for an accommodation destination LU is executed within the RAID group, the amount of the bandwidth accommodation is converted into a busy rate increment by the busy rate calculating unit 545. Then, the converted busy rate increment is added to the RAID group busy rate L, whereby the RAID group busy rate L included in the table area 214 is updated. The sequence of the conversion into the busy rate increment and the like will be described later with reference to FIGS. 27, 28, 30, and 31.

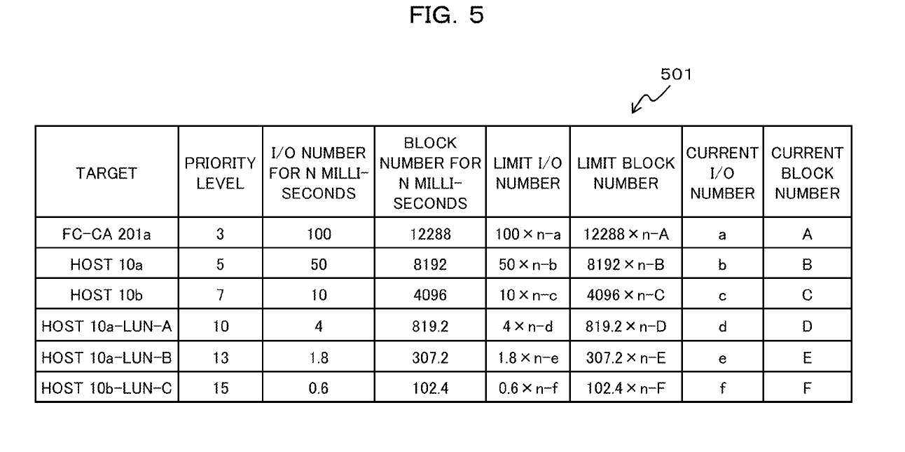

Next, an example of the QoS management table 501 will be described with reference to FIG. 5. FIG. 5 is a diagram that illustrates an example of the QoS management table 501. As illustrated in FIG. 5, the QoS management table 501 stores information associated with a “target”, a “priority level”, an “N milli-second I/O number”, an “N milli-second block number”, a “current I/O number”, a “current block number”, a “current I/O number”, and a “current block number”.

Here, the “target” stored in the QoS management table 501 represents a target for setting a priority level. Here, each of a “port”, a “host”, a “combination of a host and a LUN”, and a “combination of a port and a LUN” is a target for setting the priority level. For example, in the “target”, “FC—CA 201a”, “host 10a”, “host 10a—LUN-A”, or the like is stored. In description presented below, in a case where a “combination of a host and a LUN” or a “combination of a port and a LUN” is represented as the “target”, it will be described as only “a LU” as is appropriate.

The “priority level” represents the degree of priority set to the target. Here, it is assumed that, as the priority level, one of levels of 15 ranks from 1 to 15 is set. In the “priority level”, for example, a level such as “3”, “5”, or “7” is stored.

The “N milli-second I/O number” represents the number of I/Os (the number of input/output requests or the number of input/output requests) that can be executed within a predetermined time (N milli-seconds). Here, as the predetermined time (N milli-seconds), for example, 10 milli-seconds, in other words, N=10 is set. In addition, in the “N milli-second I/O number”, a value such as “100”, “50”, or “10” is stored.

The “N milli-second block number” represents the number of blocks that can be recorded within a predetermined time (N milli-seconds). The number of blocks is calculated based on the communication amount (MB/s) per unit time with one block being set as 512 bytes. Here, as the predetermined time (N milli-seconds), for example, ten milli-seconds is set. In other words, in the “N milli-second block number”, as the number of blocks that can be recorded within 10 milli-seconds, a value such as “12,288”, “8,192”, or “4,096” is stored.

The “limit I/O number” represents an upper limit of the number of I/Os (input/output processing amount) that can be executed at the current time point. The limit I/O number is calculated by subtracting a “current I/O number” to be described later from a value acquired by multiplying the “N milli-second I/O number” by the “number (n) of times of elapsing of N milli-seconds”. For example, in the “limit I/O number”, a value such as “100×n−a”, “50×n−b”, or “10×n−c” is stored. Here, “n” is the “number of times of elapsing of N milli-seconds”, and “a” to “c” represent the value of a corresponding “current I/O number” to be described later.

The “limit block number” represents an upper limit of the number of blocks (input/output processing amount) that can be recorded at the current time point. The limit block number is calculated by subtracting a “current block number” to be described later from a value acquired by multiplying the “N milli-second block number” by the “number (n) of times of elapsing of N milli-seconds”. For example, in the “limit block number”, a value such as “12288×n−A”, “8192×n−B”, or “4096×n−C” is stored. Here, “n” is the “number of times of elapsing of N milli-seconds”, and “A” to “C” represent the value of a corresponding “current block number” to be described later.

The “current I/O number” represents an accumulated value of I/O numbers requested until a predetermined time. For example, in the “current I/O number”, “a”, “b”, “c”, or the like is stored. The “current block number” represents an accumulated value of block numbers requested until a predetermined time. For example, in the “current block number”, “A”, “B”, “C”, or the like is stored.

In the example illustrated in FIG. 5, the QoS management table 501 represents that the priority level of the “port” is “3”, the “N milli-second I/O number” is “100”, and the “N milli-second block number” is “12288”. In addition, the QoS management table 501 represents that the “limit I/O number” is “100×n−a”, the “limit block number” is “12288×n−A”, the “current I/O number” is “a”, and the “current block number” is “A”.

In addition, the “target”, the “priority level”, the “N milli-second I/O number”, and the “N milli-second block number” stored in the QoS management table 501 are values that are initially set by the bandwidth setting unit 503 to be described later. Furthermore, the “limit I/O number”, the “limit block number”, the “current I/O number”, and the “current block number” stored in the QoS management table 501 are values that are updated every N milli-seconds.

[1-5-2] Standby Queue Storing Unit

The standby queue storing unit 502 is a queue and stores a command scheduled after the elapse of a predetermined time among commands received by the command reception unit 504. In addition, the standby queue storing unit 502 is provided for each combination of a host and a LUN or each combination of a port and a LUN (for each LU).

[1-5-3] Bandwidth Setting Unit

The bandwidth setting unit 503 sets values received from a supervisor to the “target”, the “priority level”, the “N milli-second I/O number”, and the “N milli-second block number” among the information stored in the QoS management table 501. In addition, the bandwidth setting unit 503 also has a function for setting various conditions for micro bandwidth accommodation (micro performance accommodation) and macro bandwidth accommodation (macro performance accommodation) to be described later, values relating to the various conditions, and the like with reference to Table 1 in accordance with an instruction from the supervisor. Furthermore, the supervisor sets values relating to the priority level and various conditions and the like with the bandwidth of each host 10, an application executed by each host 10, and the like being taken into consideration. In addition, in a case where the host 10 connecting to the storage apparatus 100 or the combination (LU) of the host 10 and the LUN is changed, the bandwidth setting unit 503 updates information stored in the QoS management table 501.

[1-5-4] Command Reception Unit

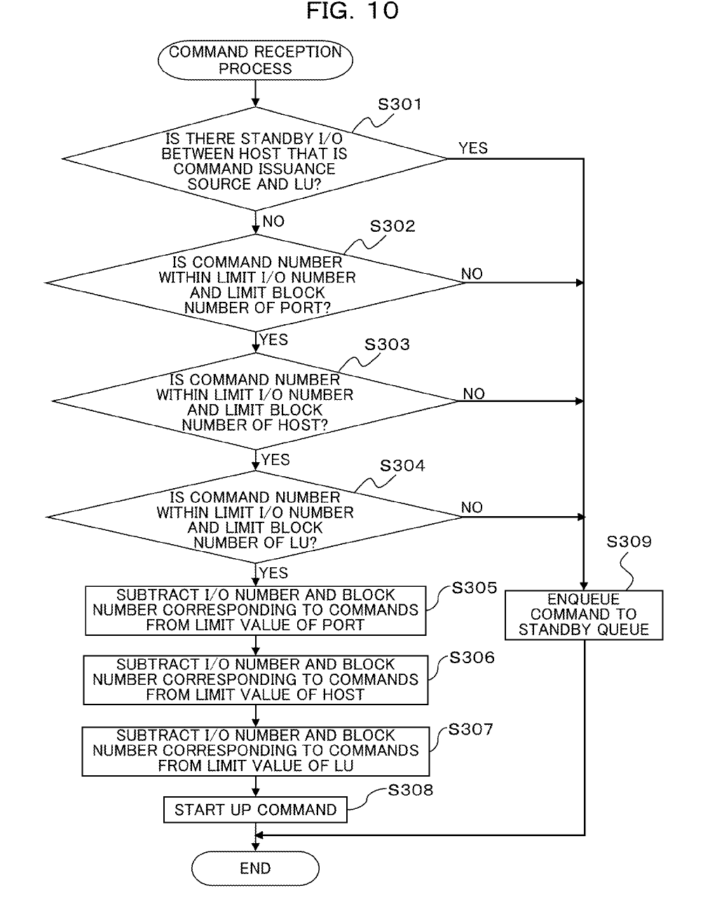

The command reception unit 504 receives and accepts a command (an input/output request) from the host 10 and determines whether or not there is a command waiting for being executed. For example, in a case where it is determined that there is a command waiting for being executed, the command reception unit 504 stores the received command in the standby queue storing unit 502. On the other hand, in a case where it is determined that there is no command waiting for being executed, the command reception unit 504 causes the scheduling unit 506 to be described later to schedule the execution sequence of the received command. A detailed operation (the processing sequence of a command reception process) of the command reception unit 504 will be described later with reference to FIG. 10.

[1-5-5] Calculation Unit

The calculation unit 505 calculates upper limits (in other words, the limit I/O number and the limit block number) of the input/output processing amount that is determined based on a priority level set for each of the host 10, the port, and the LU for every predetermined time (N milli-seconds). Here, the calculation unit 505 will be assumed to calculate the limit I/O number and the limit block number for every 10 milli-seconds in the description. For example, the calculation unit 505 adds an N milli-second I/O number to the limit I/O number every 10 milli-seconds. In addition, the calculation unit 505 adds an N milli-second block number to the limit block number for every 10 milli-seconds. The calculation unit 505 stores the limit I/O number and the limit block number that have been calculated in the QoS management table 501.

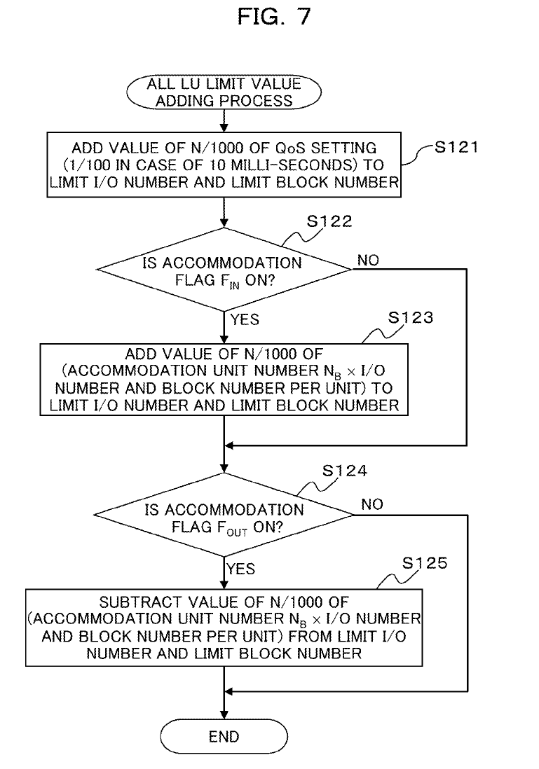

In addition, the calculation unit 505 has functions as below so as to respond to the macro bandwidth accommodation to be described later. The calculation unit 505, as described above, adds the N milli-second I/O number to the limit I/O number of the accommodation destination LU (an LU of which the accommodation flag F_{IN} is “On”) and further adds an I/O number corresponding to an accommodation unit number N_{B} to be described later thereto for every 10 milli-seconds (see FIG. 7). Similarly, the calculation unit 505, as described above, adds the N milli-second block number to the limit block number of the accommodation destination LU and further adds a block number corresponding to the accommodation unit number N_{B} thereto for every 10 milli-seconds (see FIG. 7).

On the other hand, the calculation unit 505 subtracts the I/O number corresponding to the accommodation unit number N_{B} from a value acquired by adding the N milli-second I/O number to the limit I/O number of the accommodation source LU (an LU of which an accommodation flag F_{OUT} is “On”) as described above for every 10 milli-seconds (see FIG. 7). Similarly, the calculation unit 505 subtracts the block number corresponding to the accommodation unit number N_{B} from a value acquired by adding the N milli-second block number to the limit block number of the accommodation source LU as described above for every 10 milli-seconds (see FIG. 7).

[1-5-6] Scheduling Unit

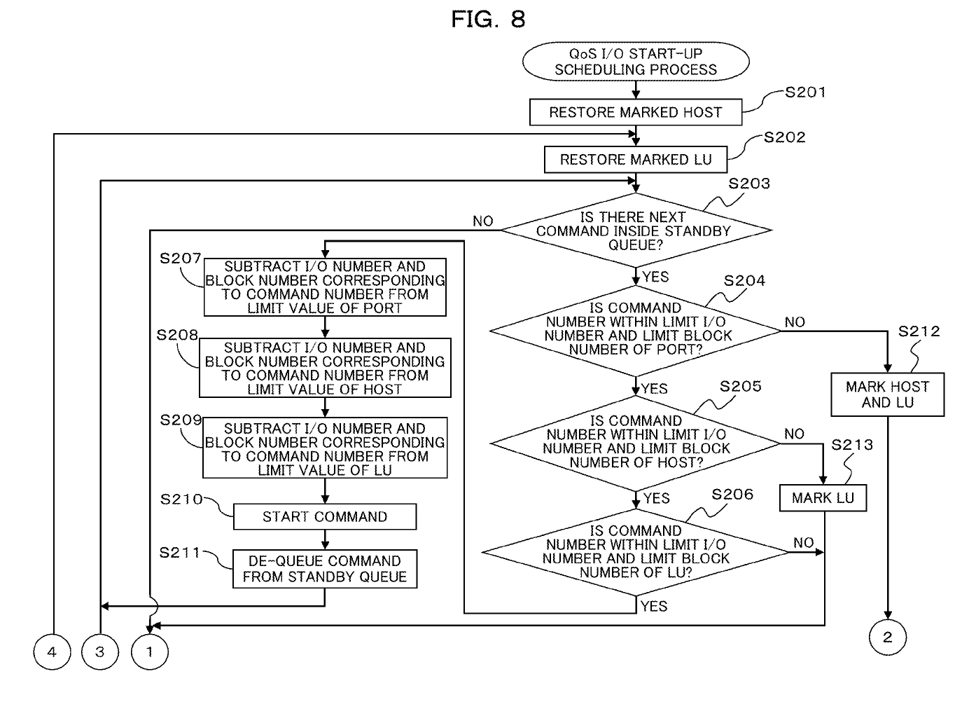

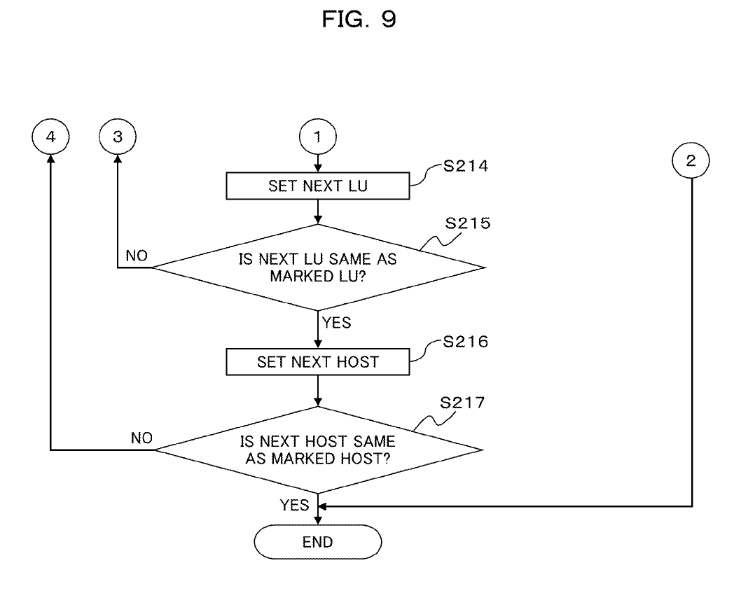

The scheduling unit 506 schedules the execution sequence of commands based on the command number received from the host 10 and the limit I/O number and the limit block number calculated by the calculation unit 505. For example, the scheduling unit 506 schedules the execution sequence of commands every time when a predetermined time elapses. A detailed operation (the processing sequence of the QoS I/O startup scheduling process) of the scheduling unit 506 will be described later with reference to FIGS. 8 and 9.

In addition, the scheduling unit 506 recovers a marked host and a marked LUN. Then, the scheduling unit 506 performs the following process in order from a combination of the host and the LUN that have been recovered. The marking of the host and the marking of the LUN will be described later.

First, the scheduling unit 506 determines whether or not the command number received from the host 10 can be processed within the limit I/O number and the limit block number of each of the host, the port, and the LUN that are calculated by the calculation unit 505. Here, in a case where it is determined that the received command number is within the limit I/O number and the limit block number and can be processed, the scheduling unit 506 causes the execution unit 507 to start up the command.

In addition, in a case where it is determined that the command number can be processed, the scheduling unit 506 stores a value acquired by adding an I/O number corresponding to the started command to the “current I/O number” stored in the QoS management table 501 in the “current I/O number”. Similarly, in a case where it is determined that the command number can be processed, the scheduling unit 506 stores a value acquired by adding a block number corresponding to the started command to the “current block number” stored in the QoS management table 501 in the “current block number”.

In addition, in a case where it is determined that the command number can be processed, the scheduling unit 506 stores a value acquired by subtracting the I/O number corresponding to the started command from the “limit I/O number” stored in the QoS management table 501 in the “limit I/O number”. Similarly, in a case where it is determined that the command number can be processed, the scheduling unit 506 stores a value acquired by subtracting the block number corresponding to the started command from the “limit block number” stored in the QoS management table 501 in the “limit block number”.

On the other hand, in a case where it is determined that the received command number is not within the limit I/O number and the limit block number, after a predetermined time elapses, the scheduling unit 506 determines whether or not the command number received from the host 10 is within the limit I/O number and the limit block number that have been newly calculated.

For example, in a case where the received command number is determined not to be within the limit I/O number and the limit block number of the port, the scheduling unit 506 marks the combination of the host and the LUN and, after a predetermined time elapses, executes the schedule from the marked combination of the host and the LUN. In addition, for example, in a case where it is determined that the received command number is within the limit I/O number and the limit block number of the port but is not within the limit I/O number and the limit block number of the host, the scheduling unit 506 marks the LUN. Then, the scheduling unit 506 sets the next LUN and determines whether or not the command number received from the host 10 is within the limit I/O number and the limit block number that have been newly calculated. Here, in a case where there is no next LUN, the scheduling unit 506 sets the next host and determines whether or not the received command number is within the limit I/O number and the limit block number that have been newly calculated.

In addition, in a case where it is determined that there is no command waiting for being executed by the command reception unit 504, the scheduling unit 506 schedules the execution sequence of commands without waiting for the elapse of the predetermined time. For example, the scheduling unit 506 determines whether or not the command number received from the host 10 can be processed within the limit I/O number and the limit block number of each other the host, the port, and the LUN that are calculated by the calculation unit 505. Here, in a case where it is determined that the command number received from the host 10 cannot be performed within the limit I/O number and the limit block number of any one of the port, the host, and the LUN, the scheduling unit 506 stores the command in the standby queue storing unit 502. Then, after a predetermined time elapses, the scheduling unit 506 determines whether or not the command number received from the host 10 is within the limit I/O number and the limit block number that have been newly calculated.

[1-5-7] Execution Unit

The execution unit 507 dequeues a command from the standby queue storing unit 502 in the execution order scheduled by the scheduling unit 506 and starts up the command so as to perform the input/output process.

[1-5-8] Micro Bandwidth Accommodation and Macro Bandwidth Accommodation

Next, before the macro accommodation checking unit 510, the macro accommodation processing unit 520, the macro accommodation restoration processing unit 530, and the micro accommodation processing unit 540 are be described, two types of bandwidth accommodation systems employed in this embodiment will be described. The two types of bandwidth accommodation systems are a micro bandwidth accommodation system and a macro bandwidth accommodation system.

In addition, hereinafter, the adjustment of the upper limit of the input/output processing amount, in other words, the bandwidth limit value of each LU (or each host) for improving the processing bandwidth of the storage apparatus 100 will be referred to as “bandwidth accommodation (flexibility of performance)”. In the “bandwidth accommodation”, a LU of which the bandwidth limit value is changed to be raised so as to resolve the insufficiency of the processing bandwidth is called a “accommodation destination LU”. In addition, in the “bandwidth accommodation”, in a case where the bandwidth limit value of the “accommodation destination LU” is raised, the bandwidth limit value of an LU having processing bandwidth to spare is changed to be lowered by an amount corresponding to the raise of the bandwidth limit value of the “accommodation destination LU”. In this way, bandwidth accommodation from the LU having processing bandwidth to spare to the “accommodation destination LU” is performed. As described above, the “LU having processing bandwidth to spare” that accommodates the processing bandwidth to the “accommodation destination LU” is called a “accommodation source LU”.

The “micro bandwidth accommodation” is an effective system that is used when a temporary spike performance or the like is absorbed. In the “micro bandwidth accommodation”, for example, at the cycle (micro cycle) of one second or less, the processing bandwidth is accommodated to a LU having insufficient processing bandwidth from a LU having processing bandwidth to spare. The accommodation amount (a micro accommodation unit number N_{H} to be described later) at this time is neither stored nor reflected on the adjustment of the bandwidth limit value at the next micro cycle. Accordingly, the storage apparatus 100 operates with the original processing bandwidth at the next micro cycle. As above, since the “micro bandwidth accommodation” is temporary accommodation, by using the “micro bandwidth accommodation”, a large amount of bandwidth accommodation can be made at a time.

The “macro bandwidth accommodation” is a system for learning and adjusting a bandwidth accommodation amount (the adjustment amount of the bandwidth limit) and causing the processing bandwidth of each LU to follow the actual input/output performance in a case where the processing bandwidth requested from the host 10 changes to various statuses. In the “macro bandwidth accommodation”, for example, the processing bandwidth is monitored at a long cycle (macro cycle), for example, of two seconds or more. Then, the processing bandwidth is accommodated to a LU of which the bandwidth is insufficient for a predetermined time (for example, one macro cycle) from a LU having processing bandwidth to spare for the predetermined time. In this way, according to the “macro bandwidth accommodation”, the bandwidth accommodation amount is adjusted based on learning, and accordingly, a continuous change in the processing bandwidth requested from the host 10 can be effectively responded.

In the “macro bandwidth accommodation” according to this embodiment, for each LU, by checking the insufficiency of the processing bandwidth or room for the processing bandwidth to spare, for example, every one second, it is determined whether to perform macro bandwidth accommodation for every macro cycle of two seconds or more. For example, within one macro cycle, for every one second, it is checked whether the processing bandwidth is insufficient or whether there is room for processing bandwidth to spare. At this time, a condition that an accommodation destination LU of which the processing bandwidth is insufficient is constantly present within one macro cycle, and an accommodation source LU having room for the processing bandwidth to spare is constantly present within one macro cycle is set as the condition for the execution of the macro bandwidth accommodation. In a case where the execution condition for the macro bandwidth accommodation is satisfied, macro bandwidth accommodation from the accommodation source LU to the accommodation destination LU is performed by a value corresponding to a predetermined unit of bandwidth accommodation.

In addition, in the “macro bandwidth accommodation” according to this embodiment, the changing of the accommodation amount per one macro cycle is performed by a value corresponding to a predetermined unit of bandwidth accommodation (unitary unit). In this embodiment, the input/output processing amount of the value corresponding to the predetermined unit of bandwidth accommodation (unitary unit) is set to a minimum interval of the input/output processing amount (the bandwidth values MB/s and IOPS) determined based on the priority level or less. Hereinafter, the input/output processing amount of the value corresponding to the predetermined unit of bandwidth accommodation will be referred to as a “unit”. For example, in the correspondence relation between the priority level and the bandwidth value illustrated in FIG. 4, since the minimum intervals of the bandwidth value for the priority level are 5 MB/s and 60 IOPS, for example, “one unit” is set as 5 MB/s and 60 IOPS.

Here, as described above, a case will be described in which a conventional technology responding to a change in the load status by changing the priority level is used. In such a case, in the example illustrated in FIG. 4, the change intervals (accommodation amounts) of the bandwidth limits in the range of priority levels 1 to 7 are 100 for the bandwidth value MB/s and 2500 or 2000 for the bandwidth value IOPS and are much larger than the change intervals (accommodation amounts) in the range of the priority levels 8 to 15. When the change interval of the bandwidth limit value is larger, by only raising/lowering the priority level, the adjustment range is limited, and accordingly, a change in the bandwidth requested from the host 10 is difficult to be delicately followed. In contrast to this, in the “macro bandwidth accommodation” according to this embodiment, the bandwidth accommodation is performed in units of the minimum intervals of 5 MB/s and 60 IOPS of the bandwidth values for the priority level as “one unit”. Accordingly, the change interval (accommodation amount) of the bandwidth limit is much smaller than that of a case where the bandwidth limit is changed by changing the priority level. Thus, a change in the processing bandwidth requested from the host 10 can be delicately followed, whereby various performance changes can be responded.

In this embodiment, any one of the micro bandwidth accommodation and the macro bandwidth accommodation may be used based on the characteristics of the micro bandwidth accommodation and the macro bandwidth accommodation described above, or both thereof may be used together. In a case where only one thereof is used, by appropriately setting parameters and the like represented in Table 1, more effective accommodation is performed. On the other hand, in a case where both thereof are used, by performing control such that the micro bandwidth accommodation is used for absorbing a temporary spike performance and the like, and the macro bandwidth accommodation is used for absorbing a continuous performance change, the characteristics of the both thereof can be effectively used.

Next, various conditions for the micro bandwidth accommodation and the macro bandwidth accommodation, values relating to the various conditions, and the like will be described with reference to the following Table 1. As described above, the various conditions, the values relating to the various conditions, and the like are set in accordance with an instruction from a supervisor by the bandwidth setting unit 503. The micro bandwidth accommodation and the macro bandwidth accommodation are performed based on the various conditions and values set as in Table 1.

As illustrated in the following Table 1, in the “micro bandwidth accommodation” and the “macro bandwidth accommodation”, various conditions and values are set and used as below. As the various conditions and the values, a “cycle”, the “number of accommodating LUs in one cycle”, a “accommodation number limit”, a “accommodation amount”, a “condition for receiving accommodation”, a “condition for accommodation”, and a “return condition” are set.

TABLE 1

| | MICRO BANDWIDTH | MACRO BANDWIDTH |
|---|---|---|
| | ACCOMMODATION | ACCOMMODATION |
| CYCLE | FOR EXAMPLE, 0.5 SECONDS | FOR EXAMPLE, 30 SECONDS |
| NUMBER OF | MAXIMUM OF 4 LUs. | MAXIMUM OF 4 LUs. |
| ACCOMMODATING LUs | TUNING UP TO 16 LUs CAN | TUNING UP TO 16 LUs CAN |
| IN ONE CYCLE | BE PERFORMED. | BE PERFORMED. |
| ACCOMMODATION | UP TO 4 TIMES PER ONE | NONE. |
| NUMBER LIMIT | CYCLE OF MACRO | THERE ARE UPPER LIMIT |
| | ACCOMMODATION. | AND LOWER LIMIT OF |
| | TUNING CAN BE PERFORMED. | BANDWIDTH VALUES. |
| ACCOMMODATION | ACCOMMODATION AMOUNT OF | ACCOMMODATION OF ONE |
| AMOUNT | ONE TIME IS TWICE SET | TIME IS IN UNITARY UNIT. |
| | PERFORMANCE. | ONE UNIT, FOR EXAMPLE, |
| | TUNING CAN BE PERFORMED. | IS BI-DIRECTIONAL |
| | | SIMULTANEOUS |
| | | ACCOMMODATION AT 60 IOPS |
| | | AND 5 MB/s. |
| CONDITION FOR | DETECTION OF STANDBY | DETECTION OF |
| RECEIVING | I/Os (NUMBER OF I/Os OR | INSUFFICIENT PROCESSING |
| ACCOMMODATION | NUMBER OF BLOCKS). | BANDWIDTH CONTINUOUSLY |
| | | FOR 30 SECONDS. |
| CONDITION FOR | THERE IS ABOVE-DESCRIBED | THERE IS PROCESSING |
| ACCOMMODATION | ACCOMMODATION AMOUNT OR | BANDWIDTH TO SPARE |
| | MORE TO SPARE. | CONTINUOUSLY FOR 30 |
| | | SECONDS. |
| RETURN CONDITION | — | DETECTION OF |
| | | INSUFFICIENT PROCESSING |
| | | BANDWIDTH IN LU |
| | | (ACCOMMODATION SOURCE |
| | | LU) ACCOMMODATED TO |
| | | OTHER. |
| | | AT TIME OF CHANGING |
| | | SETTING RELATING TO QoS. |

The “cycle” is a cycle at which the bandwidth accommodation is performed. The “cycle” (micro cycle) at which the micro bandwidth accommodation is performed, for example, is set to 0.5 seconds, and the cycle (macro cycle) at which the macro bandwidth accommodation is performed, for example, is set to 30 seconds.

The “number of accommodating LUs in one cycle” is an upper limit of the number of LUs for which the bandwidth accommodation is performed within one cycle. The “number of accommodating LUs in one cycle” of the micro bandwidth accommodation, for example, is a maximum of 4 LUs (default) and can be tuned up to 16 LUs. In addition, the “number of accommodating LUs in one cycle” of the macro bandwidth accommodation, for example, is a maximum of 4 LUs (default) and can be tuned up to 16 LUs.

The “accommodation number limit” is information that relates to the limit of the number of times of executing the bandwidth accommodation. The “accommodation number limit” of the micro bandwidth accommodation, for example, is up to four times per one cycle (macro cycle; 30 seconds) of the macro bandwidth accommodation for one LU and can be tuned. In addition, the “accommodation number limit” of the macro bandwidth accommodation is set as “none”. However, the upper limit and the lower limit thereof are set.

The “accommodation amount” is the amount that is accommodated per one time of executing bandwidth accommodation. The “accommodation amount” of the micro bandwidth accommodation, for example, is set as twice the set bandwidth (for example, a bandwidth value set in accordance with the priority level illustrated in FIG. 4) per one time and can be tuned. In addition, the “accommodation amount” of the macro bandwidth accommodation, for example, is set as the above-described one unit (a value corresponding to a predetermined unit of bandwidth accommodation) per one time, in other words, the accommodation is executed at the same time at both 60 IOPS and 5 MB/s.

The “condition for receiving accommodation” is a condition for a LU to receive bandwidth accommodation from another LU, in other words, a condition for a LU to be an accommodation destination LU. The condition for “receiving accommodation” of the micro bandwidth accommodation is that the LU has detected standby I/Os (the I/O number or the block number). In addition, the condition for “receiving accommodation” of the macro bandwidth accommodation is that the LU has detected insufficiency of the processing bandwidth continuously for 30 seconds (first predetermined time).

The “condition for accommodation” is a condition for an LU to accommodate the bandwidth to another LU, in other words, a condition for a LU to be an accommodation source LU. The “condition for accommodation” of the micro bandwidth accommodation is that there is equal to or more than the “accommodation amount” to spare at the time of performing micro accommodation. In addition, the “condition for accommodation” of the macro bandwidth accommodation is that there is processing bandwidth to spare in the LU continuously for 30 seconds (second predetermined time).

The “return condition” is a condition for returning (recovering) the input/output processing amount accommodated from the accommodation source LU to the accommodation destination LU from the accommodation destination LU to the accommodation source LU. In the micro bandwidth accommodation, as described above, the accommodation amount is not stored, and the storage apparatus 100 operates with the original processing bandwidth at the next micro cycle, and accordingly, the “return condition” of the micro bandwidth accommodation is not set. In addition, the “return condition” of the macro bandwidth accommodation is set as detecting bandwidth insufficiency in the accommodation source LU that has performed the bandwidth accommodation for another LU. Furthermore, the returning (recovering) of the macro bandwidth accommodation is performed also when a setting relating to the QoS is changed.

[1-5-9] Bandwidth Accommodation Information of LU

Next, the bandwidth accommodation information of each LU that is maintained in the QoS control area 213 for each LU (LUN #1 to #m; here, m is an integer equal to or greater than two), as illustrated in FIG. 3, for executing the micro bandwidth accommodation and the macro bandwidth accommodation described above will be described. In other words, in the QoS control area 213, for each LU, for example, six kinds of accommodation flags F_{IN}, F_{OUT}, F_{INMAx}, F_{OUTMAX}, F_{MINCIN}, and F_{MICOUT} and eight kinds of numerical values N_{B}, N_{C}, N_{D}, N_{E}, N_{F}, N_{G}, N_{H}, and N_{I} are stored as the bandwidth accommodation information. The accommodation flags and the numerical values are set by the bandwidth setting unit 503 in accordance with an instruction from a supervisor or are set and updated based on the function of the SCSI target control unit 303 during the execution of the micro bandwidth accommodation and the macro bandwidth accommodation.

The accommodation flag F_{IN} is set to On in a case where the target LU receives macro bandwidth accommodation from another LU, in other words, in a case where the target LU is the accommodation destination LU and is set to Off in any other case.

The accommodation flag F_{OUT} is set to On in a case where the target LU performs macro bandwidth accommodation for another LU, in other words, in a case where the target LU is the accommodation source LU and is set to Off in any other case.

The accommodation flag F_{INMAX} is set to On in a case where the accommodation amount of the macro bandwidth accommodation received by the target LU from another LU has arrived at an upper limit set in advance (at the time of arrival at the upper limit) and is set to Off in any other case.

The accommodation flag F_{OUTMAX} is set to On in a case where the accommodation amount of the macro bandwidth accommodation from the target LU to another LU has arrived at a lower limit set in advance (at the time of arrival at the lower limit) and is set to Off in any other case.

The accommodation flag F_{MICIN} is set to On in a case where the target LU receives micro bandwidth accommodation from another LU and is set to Off in any other case.

The accommodation flag F_{MICOUT} is set to On in a case where the target LU performs micro bandwidth accommodation for another LU and is set to Off in any other case.

The accommodation unit number N_{B} is the number of units corresponding to an accommodation amount of a case where the target LU receives macro bandwidth accommodation by the target LU from another LU or a case where the target LU performs macro bandwidth accommodation for another LU. Here, the accommodation unit number N_{B} is a value acquired by converting the accommodation amount into a number of the value corresponding to the predetermined unit of bandwidth accommodation described above.

The standby I/O number N_{C} is the number of I/Os (input/output requests or commands from the host 10) of the target LU that are in the standby state in the QoS control process.

The standby block number N_{D} is the total number of blocks of I/Os (input/output requests or commands from the host 10) of the target LU that are in the standby state in the QoS control process.

The standby I/O number N_{C} and the standby block number N_{D} are converted into a unit number (the number of standby units) corresponding to the standby-state I/Os in the QoS control process.

The minimum residual unit number N_{E} is a minimum value (minimum residual amount) of the residual unit number N_{I} for every one second in the target LU. Here, the residual unit number N_{I} is a value acquired by converting the residual processing amount into the number of the value corresponding to the above-described predetermined units of bandwidth accommodation in correspondence with a residual processing amount (residual value) of the processing amount relating to I/Os for the target LU with respect to the processing bandwidth of the target LU.

The minimum standby unit number N_{F} is a minimum value (minimum standby amount) of the standby units in the target LU for every one second. Here, the standby unit number, as described above, is the number of units corresponding to the standby-state I/Os in the QoS control process that is a value converted from the standby I/O number N_{C} and the standby block number N_{D}.

The micro accommodation number N_{G} is a value corresponding to the “accommodation number limit” (see Table 1) when the target LU performs the micro bandwidth accommodation and is a limit value (for example, four times) of the number of times of executing the micro bandwidth accommodation in the target LU within one macro cycle (for example 30 seconds).

The micro accommodation unit number N_{H} is the number of units corresponding to a temporary accommodation amount received by the target LU from another LU through the micro bandwidth accommodation of this time or a temporary accommodation amount that is accommodated by the target LU to another LU. In other words, the micro accommodation unit number N_{H} is a value acquired by converting the temporary accommodation amount into the number of the value corresponding to the above-described predetermined units of bandwidth accommodation.

The residual unit number N_{I}, as presented above in the description of the minimum residual unit number N_{E}, corresponds to a residual processing amount (residual value) of the processing amount relating to the I/Os for the target LU with respect to the processing bandwidth of the target LU. The residual unit number N_{I} is a value acquired by converting the residual processing amount into the number of the value corresponding to the above-described predetermined units of bandwidth accommodation.

[1-5-10] Macro Accommodation Checking Unit

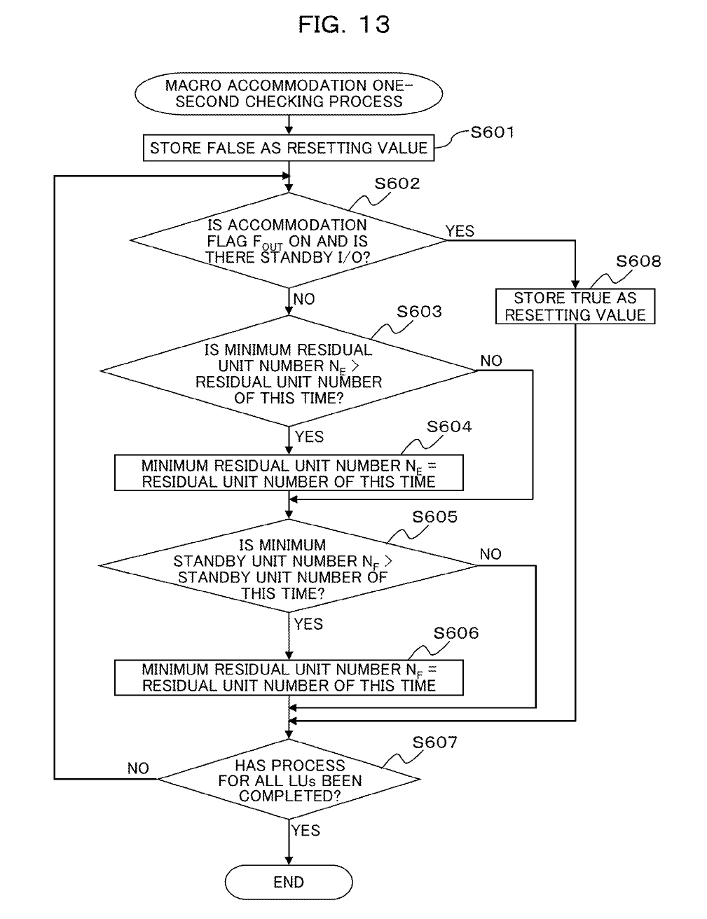

The macro accommodation checking unit 510 checks and acquires information (the minimum residual unit number N_{E} and the minimum standby unit number N_{E}) for determining whether or not the macro bandwidth accommodation is performed by first and second determination units 521 and 522. Accordingly, the macro accommodation checking unit 510 includes first and second acquisition units 511 and 512. A detailed operation (the processing sequence of a macro accommodation one-second checking process) of the macro accommodation checking unit 510 will be described later with reference to FIG. 13.

The first acquisition unit 511 acquires the minimum standby unit number N_{F} that is information for determining the above-described “condition for receiving accommodation” of the macro bandwidth accommodation by the first determination unit 521 to be described later. In other words, the first acquisition unit 511, for each LU, acquires the standby unit number (the processing standby amount of I/Os) for the LU at a time interval (for example, at an interval of one second) shorter than one macro cycle (for example 30 seconds; the first predetermined time). At this time, the standby unit number for every one second, as described above, is acquired by converting the standby I/O number N_{C} and the standby block number N_{D}.

Then, the first acquisition unit 511, for each LU, acquires a minimum value of the standby unit numbers acquired during one macro cycle as the minimum standby unit number (minimum standby amount) N_{F}. At this time, the first acquisition unit 511, every time when the standby unit number is acquired for every one second during one macro cycle, compares the standby unit number acquired this time and a value (a minimum standby unit number until the current time point) N_{F} stored in the QoS control area 213 with each other. In a case where the standby unit number acquired this time is less than the value N_{F}, the first acquisition unit 511 replaces the value N_{F} with the standby unit number acquired this time. The first acquisition unit 511 repeats the above-described process, whereby the value N_{F} stored in the QoS control area 213 at a time point when one macro cycle elapses is the minimum standby unit number N_{F}.

The second acquisition unit 512 acquires the minimum residual unit number N_{E} that is information for determining the above-described “condition for accommodation” of the macro bandwidth accommodation by the second determination unit 522 to be described later. In other words, the second acquisition unit 512, for each LU, acquires the residual unit number (the residual processing amount) for the LU at a time interval (for example, at an interval of one second) shorter than one macro cycle (for example 30 seconds; the second predetermined time). At this time, the residual unit number for every one second is acquired by referring to the residual unit number N_{I} stored in the QoS control area 213 for every one second.

Then, the second acquisition unit 512, for each LU, acquires a minimum value of the residual unit numbers N_{I} acquired during one macro cycle as the minimum residual unit number (minimum residual amount) N_{E}. At this time, the second acquisition unit 512, every time when the residual unit number N_{I} is acquired for every one second during one macro cycle, compares the residual unit number N_{I} acquired this time and a value (a minimum residual unit number until the current time point) N_{E} stored in the QoS control area 213 with each other. In a case where the residual unit number acquired this time is less than the value N_{E}, the second acquisition unit 512 replaces the value N_{E} with the residual unit number N_{I} acquired this time. The second acquisition unit 512 repeats the above-described process, whereby the value N_{E} stored in the QoS control area 213 at a time point when one macro cycle elapses is the minimum residual unit number N_{E}.

[1-5-11] Macro Accommodation Processing Unit

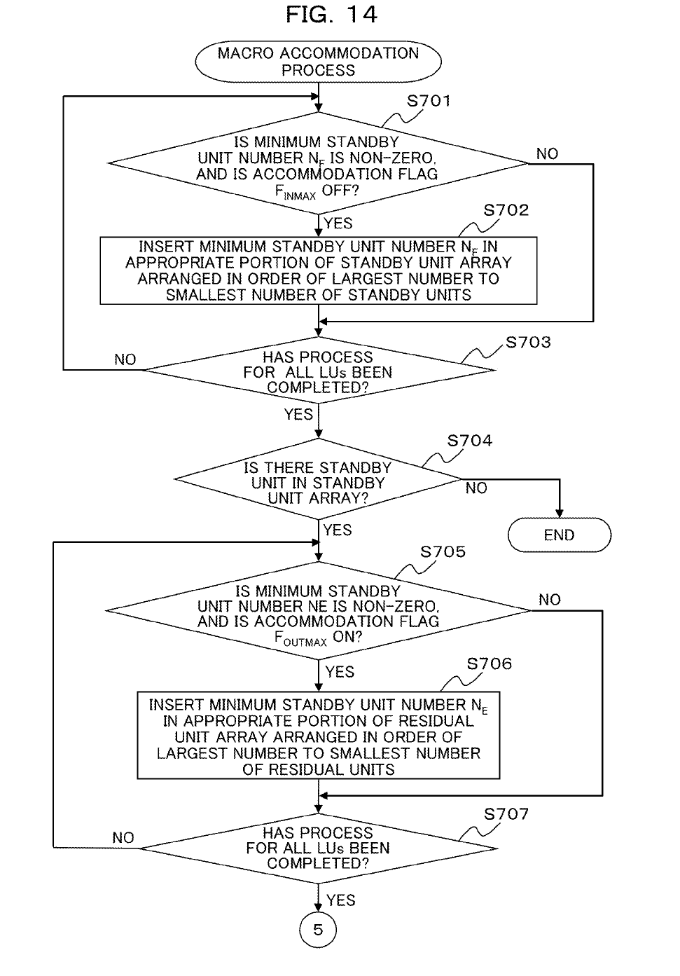

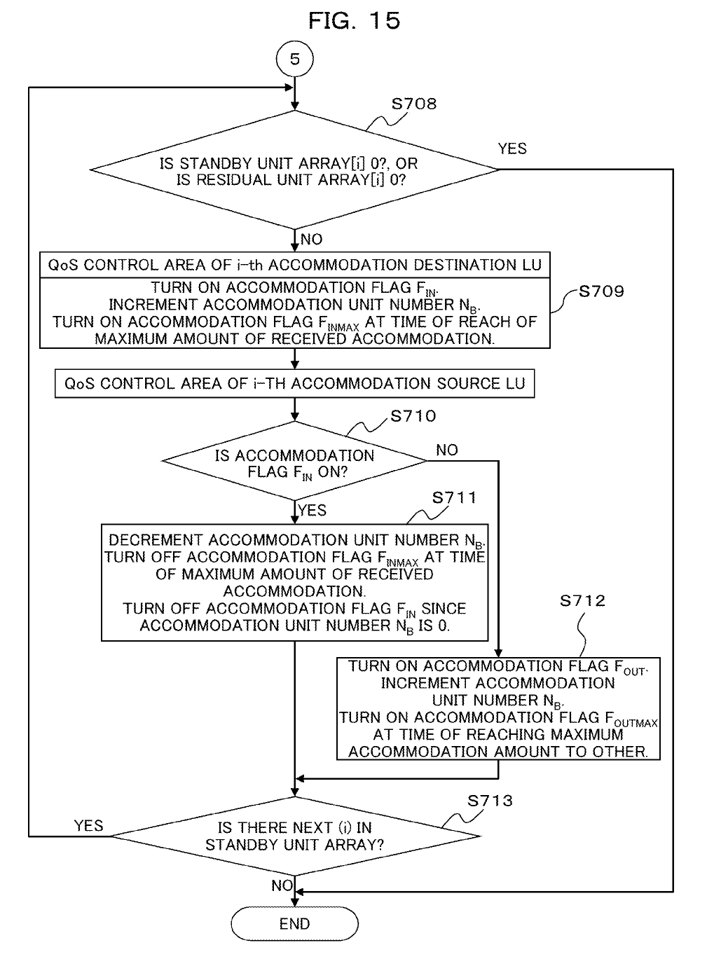

The macro accommodation processing unit 520 performs the macro bandwidth accommodation using the first and second acquisition units 511 and 512 of the macro accommodation checking unit 510 based on the minimum standby unit number N_{F} and the minimum residual unit number N_{E} that have been acquired. The macro accommodation processing unit 520 includes the first determination unit 521, the second determination unit 522, and a change unit 523. A detailed operation (the processing sequence of the macro accommodation process) of the macro accommodation processing unit 520 will be described later with reference to FIGS. 14 and 15.

The first determination unit 521 determines whether or not each LU satisfies the above-described “condition for receiving accommodation” of the macro bandwidth accommodation. In other words, the first determination unit 521, for each LU, determines whether or not the processing amount relating to I/Os for the LU exceeds the processing bandwidth of the LU for one macro cycle (the first predetermined time; 30 seconds). More specifically, in a case where the minimum standby unit number N_{F} acquired by the first acquisition unit 511 for the LU is not zero, the first determination unit 521 determines that the processing amount relating to the I/Os for the LU exceeds the processing bandwidth of the LU for one macro cycle. In other words, the first determination unit 521 determines that the LU is an accommodation destination LU satisfying the above-described “condition for receiving accommodation” of the macro bandwidth accommodation.

The second determination unit 522 determines whether or not each LU satisfies the above-described “condition for accommodation” of the macro bandwidth accommodation. In other words, the second determination unit 522, for each LU, determines whether or not the processing amount relating to I/Os for the LU exceeds the processing bandwidth of the LU for one macro cycle (the second predetermined time; 30 seconds). More specifically, in a case where the minimum residual unit number N_{E} acquired by the second acquisition unit 512 for the LU is not zero, the second determination unit 522 determines that the processing amount relating to the I/Os for the LU is below the processing bandwidth of the LU for one macro cycle. In other words, the second determination unit 522 determines that the LU is an accommodation source LU satisfying the above-described “condition for accommodation” of the macro bandwidth accommodation.

The change unit 523 changes the bandwidth limit value of the target LU in the unitary unit in accordance with results of the determinations made by the first and second determination units 521 and 522, thereby performing macro bandwidth accommodation from the accommodation source LU to the accommodation destination LU in one unitary unit. In other words, in a case where the result of the determination made by the first determination unit 521 is as illustrated in article (a1) represented below and in a case where the result of the determination made by the second determination unit 522 is as illustrated in article (a2) represented below, the change unit 523 performs a change process illustrated in article (a3) represented below.

(a1) case where one LU (first storage device) is an accommodation destination LU satisfying the above-described “condition for receiving accommodation” of the macro bandwidth accommodation as the result of the determination made by the first determination unit 521

(a2) case where another LU (second storage device) is an accommodation source LU satisfying the above-described “condition for accommodation” of the macro bandwidth accommodation as the result of the determination made by the second determination unit 522

(a3) Change Process: values corresponding to one unit are added to the bandwidth limits calculated for the accommodation destination LU by a value corresponding to the predetermined unit of bandwidth accommodation and values corresponding to one unit are subtracted from the bandwidth limits calculated for the accommodation source LU

[1-5-12] Macro Accommodation Restoration Processing Unit

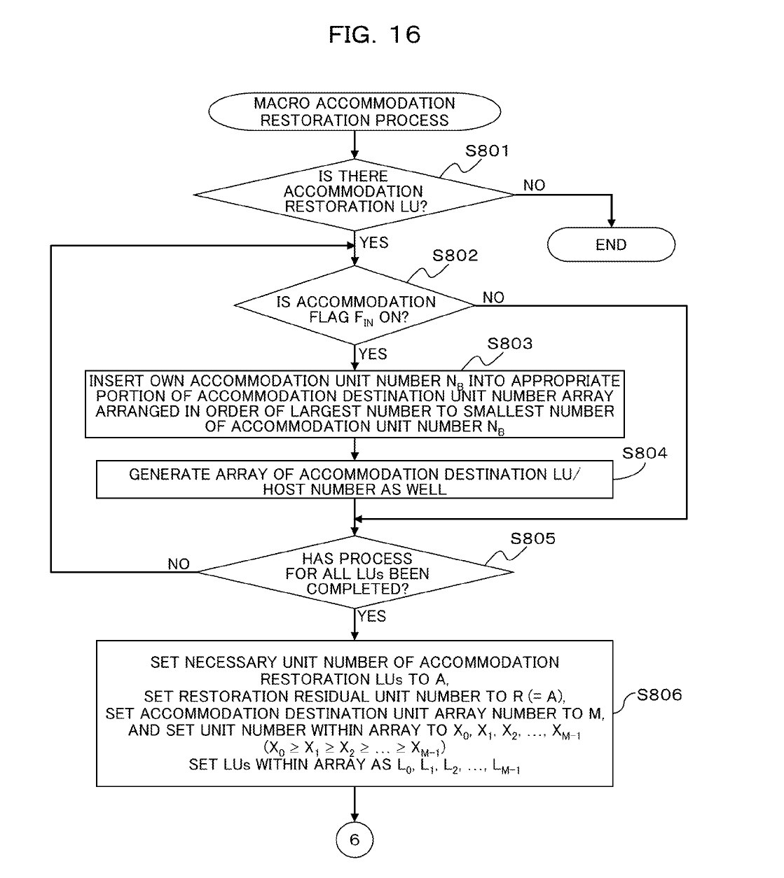

In a case where each LU satisfies the above-described “return condition”, the macro accommodation restoration processing unit 530 performs a restoration process recovering the processing amount accommodated to the accommodation destination LU from the accommodation destination LU to the accommodation source LU. The macro accommodation restoration processing unit 530 includes a third determination unit 531 and a restoration processing unit 532. A detailed operation (the processing sequence of the macro accommodation restoration process) of the macro accommodation restoration processing unit 530 (particularly, the restoration processing unit 532) will be described with reference to FIGS. 16 to 20.

The third determination unit 531 determines whether or not each LU satisfies the above-described “return condition” of the macro bandwidth accommodation. In other words, the third determination unit 531, for each LU, determines whether or not the LU is the accommodation source LU (second storage device) that has performed the macro bandwidth accommodation for one or more accommodation destination LUs (first storage device) and is an accommodation restoration target for which waiting for the I/O process for the LU occurs.

In a case where the LU is determined to be the accommodation restoration target (hereinafter, referred to as an accommodation restoration LU) by the third determination unit 531, the restoration processing unit 532 performs a restoration process returning the processing amount accommodated to other LUs by the accommodation restoration LU from one or more accommodation destination LUs to the accommodation restoration LU. At that time, the restoration processing unit 532 returns the processing amount from the one or more accommodation destination LUs to the accommodation restoration LU such that the residual amounts of the processing amounts accommodated to the one or more accommodation destination LUs are uniform or approximately uniform.

[1-5-13] Micro Accommodation Processing Unit

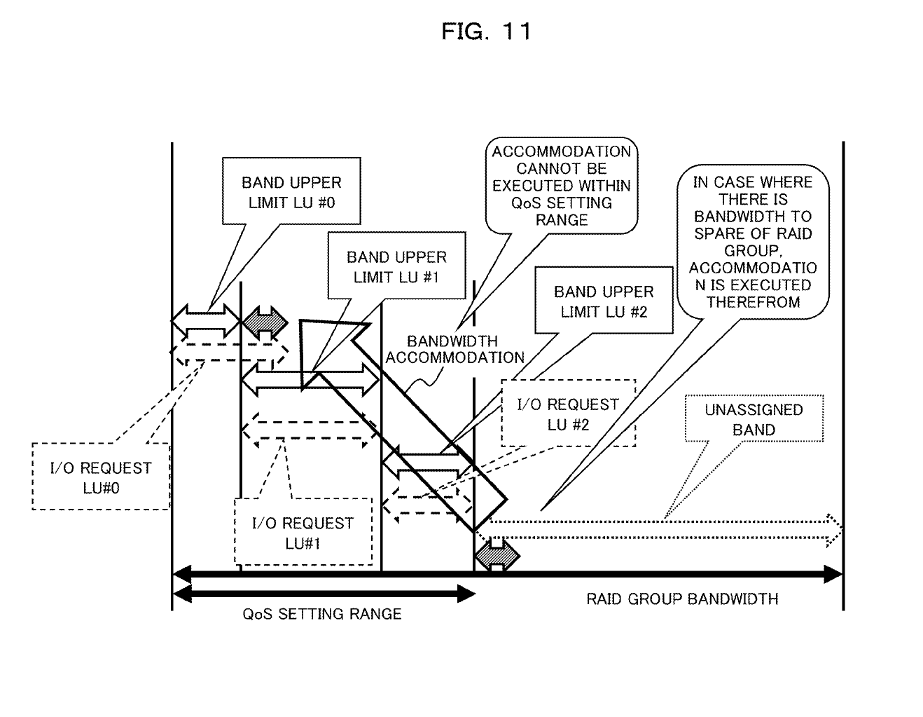

The micro accommodation processing unit 540 performs the micro bandwidth accommodation and includes a fourth determination unit 541, an accommodation processing unit 542, a post-accommodation processing unit 543, a fifth determination unit 544, and a busy rate calculating unit 545. A detailed operation (the processing sequence of the micro accommodation process and the post-process of micro accommodation) of the micro accommodation processing unit 540 will be described later with reference to FIGS. 11, 12, and 22 to 31. The number of times of the micro bandwidth accommodation performed by the micro accommodation processing unit 540 is limited to a value (for example, “4”) set in the QoS control area 213 as the micro accommodation number N_{G} for every one macro cycle.

The fourth determination unit (standby input/output request determining unit) 541 determines whether or not each LU satisfies the “condition for receiving accommodation” of the micro bandwidth accommodation. In other words, the fourth determination unit 541, for each LU, determines whether or not there is an I/O request that is in the standby state (presence/absence of an I/O request that is in the standby state).

In a case where there is an accommodation destination LU for which an I/O request that is in the standby state is determined to be present by the fourth determination unit 541, the fifth determination unit (bandwidth to spare determining unit) 544 determines the presence/absence of the bandwidth to spare of the RAID group (the storage apparatus 100) including the accommodation destination LU. At this time, in a case where the RAID group busy rate L calculated by the busy rate calculating unit 545 is less than a predetermined value (for example, 80%), the fifth determination unit 544 determines that there is a bandwidth to spare in the RAID group.

The busy rate calculating unit 545 calculates the busy rate (RAID group busy rate) L of the RAID group to which a plurality of LUs belong in the storage apparatus 100. At that time, the busy rate calculating unit 545 calculates the busy rate of each of the plurality of disk drives (HDD 101a to 101d) included in the RAID group and calculates an average busy rate of the plurality of disk drives as the RAID group busy rate L.

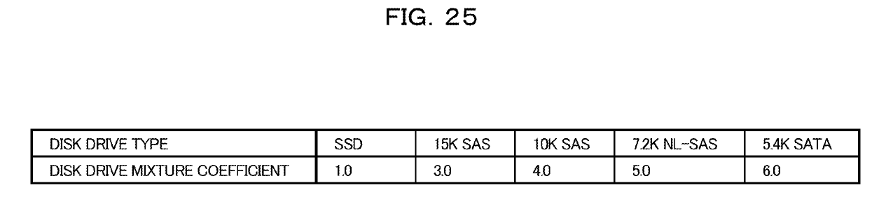

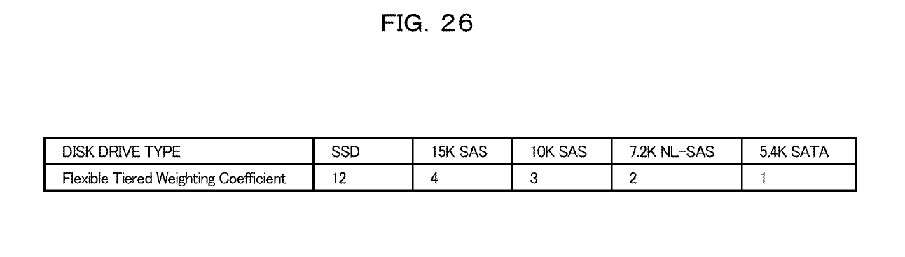

In addition, in a case where disk drives of mutually-different types are included in the plurality of disk drives, the busy rate calculating unit 545 calculates the RAID group busy rate L by multiplying the busy rate of each disk drive by a coefficient (see FIG. 25) according to the type. Furthermore, in a case where a plurality of RAID groups configure an automatic hierarchization pool (a flexible tiered pool), the busy rate calculating unit 545 calculates the RAID group busy rate L with all the disk drives included in all the RAID groups being taken into account. In other words, the busy rate calculating unit 545 multiplies each of a plurality of RAID group busy rates calculated for a plurality of RAID groups by a coefficient (see FIG. 26) according to the type of the disk drive included in each RAID group, thereby calculating the busy rate L of the entirety of the plurality of RAID groups. The calculation sequence of the RAID group busy rate L that is performed by the busy rate calculating unit 545 will be described later with reference to FIGS. 22 to 26.

Furthermore, the busy rate calculating unit 545 converts the bandwidth accommodation amount for the accommodation destination LU into a busy rate increment and uses a value acquired by adding the converted busy rate increment to the RAID group busy rate L as the RAID group busy rate L after bandwidth accommodation. The sequence of the conversion into a busy rate increment that is performed by the busy rate calculating unit 545 and the like will be described later with reference to FIGS. 27, 28, 30, and 31.

In a case where it is determined that there is a bandwidth to spare in the RAID group by the fifth determination unit 544, in other words, in a case where the RAID group busy rate L is determined to be less than a predetermined value (for example, 80%), the accommodation processing unit 542 performs bandwidth accommodation from an unassigned band of the RAID group for the accommodation destination LU. At this time, in a case where there is no accommodation source LU having a bandwidth to spare among a plurality of LUs, the accommodation processing unit 542 performs bandwidth accommodation from an unassigned band other than a plurality of LU bands of the RAID group for the accommodation destination LU. On the other hand, in a case where there is an accommodation source LU among the plurality of LUs, the accommodation processing unit 542 performs bandwidth accommodation from an unassigned band of the accommodation source LU band for the accommodation destination LU.

In other words, in this embodiment, when there is no LU having a processing bandwidth to spare, and the accommodation of the processing bandwidth to the accommodation destination LU cannot be performed, in a case where there is a bandwidth to spare in the RAID group to which the accommodation source LU belongs, micro bandwidth accommodation is performed from an unassigned band other than the LU band of the RAID group. In addition, in this embodiment, even when bandwidth accommodation from an accommodation source LU having a processing bandwidth to spare to an accommodation destination LU can be performed, in a case where there is no bandwidth to spare in the RAID group to which such a LU belongs, micro bandwidth accommodation from the accommodation source LU to the accommodation destination LU is configured not to be performed.

The accommodation processing unit 542 and the post-accommodation processing unit 543 perform micro bandwidth accommodation for an accommodation destination LU determined to satisfy a “condition for receiving accommodation” by the fourth determination unit 541. At that time, as described above, in a case where there is a bandwidth to spare in the RAID group to which the accommodation destination LU belongs, in other words, in a case where the busy rate of the RAID group is less than a predetermined value, micro bandwidth accommodation to the accommodation destination LU is performed.

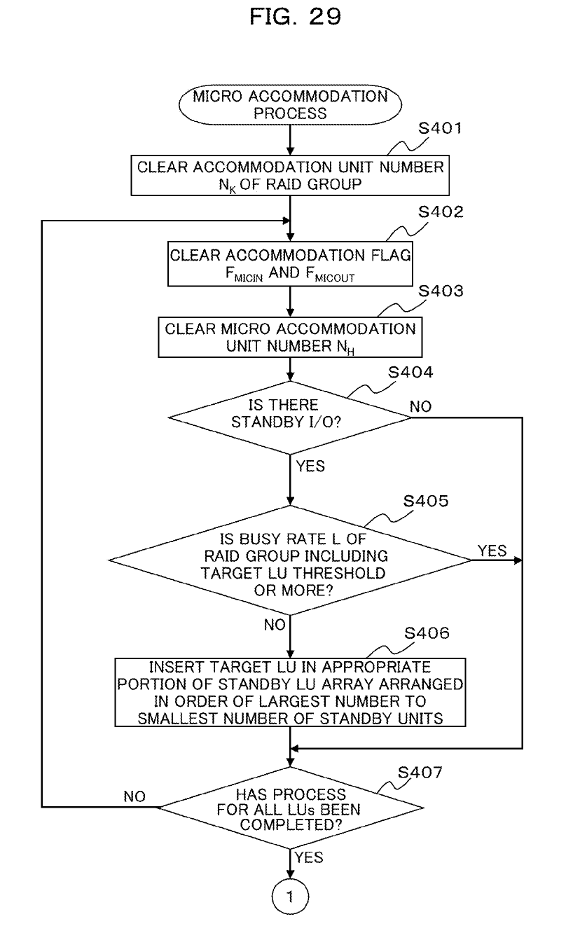

Here, the “accommodation amount” of the micro bandwidth accommodation is maintained in the QoS control area 213 as the micro accommodation unit number N_{H}. The value of the micro accommodation unit number N_{H} maintained in the QoS control area 213, as will be described later with reference to FIG. 29, is cleared at the time of starting one micro cycle. Accordingly, the micro bandwidth accommodation with an accommodation amount corresponding to the value of the micro accommodation unit number N_{H} is executed only once (one micro cycle).

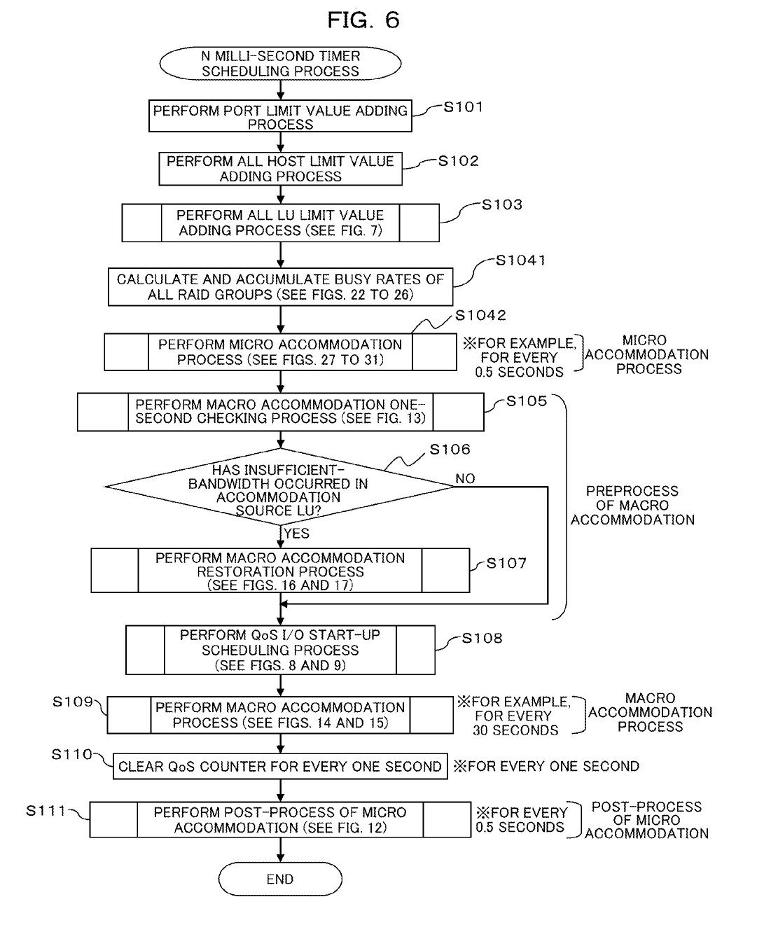

The accommodation processing unit 542 operates before the QoS I/O startup scheduling process (see FIG. 6) performed by the scheduling unit 506. The accommodation processing unit 542, for every one micro cycle, searches for accommodation destination LUs (standby LUs) having bandwidth insufficiency and, in a case where there are corresponding accommodation destination LUs, searches for accommodation source LUs (residual LUs) having the processing bandwidth to spare. Then, the accommodation processing unit 542 stores a standby LU array and a residual LU array in which the standby unit numbers of the retrieved standby LUs and the residual unit numbers of the retrieved residual LUs are respectively aligned in order of greatest to least. The accommodation processing unit 542, based on the standby LU array and the residual LU array, distributes the number (sum value) of all the residual units to the standby LUs and determines a micro accommodation unit number N_{H} for each standby LU. In addition, in a case where there is a bandwidth to spare in the RAID group as described above, the accommodation processing unit 542 sets the micro accommodation unit number N_{H} and the accommodation flags F_{MICIN} and F_{MICOUT} in the QoS control areas 213 of the standby LUs performing bandwidth accommodation and the residual LUs. Furthermore, in a case where a combination of the standby LU and the residual LU for which the micro bandwidth accommodation is performed is determined in one set, the accommodation processing unit 542 sets the micro accommodation flag (see FIG. 3) of the QoS control area 213 to be On and notifies the post-accommodation processing unit 543 that the micro bandwidth accommodation is performed.

In addition, in a case where there is a standby LU, but there is no residual LU, the accommodation processing unit 542, when there is a bandwidth to spare in the RAID group as described above, performs micro bandwidth accommodation from an unassigned band other than the LU band of the RAID group to the standby LU. At this time, the accommodation processing unit 542 determines the micro accommodation unit number N_{H} as one of the following four patterns and sets the micro accommodation unit number N_{H} and the accommodation flag F_{MICIN} in the QoS control area 213 for the standby LU. Then, the accommodation processing unit 542 sets the micro accommodation flag (see FIG. 3) of the QoS control area 213 to On and notifies the post-accommodation processing unit 543 that micro bandwidth accommodation is performed.

Pattern 1: Number of units acquired by converting the value of micro accommodation unit number N_{H}=[predetermined threshold (for example, 80%)]−[RAID group busy rate L]

Pattern 2: Micro accommodation unit number N_{H}=n times (here, n is an integer of one or more) of standby (insufficient) unit number

Pattern 3: Micro accommodation unit number N_{H}=predetermined fixed unit number

Pattern 4: Micro accommodation unit number N_{H}=number of units depending on (in proportion to) the QoS set value of a target LU (accommodation destination LU)

The accommodation processing unit 542 performs the micro accommodation process as described above in the processing sequence to be described in detail with reference to FIGS. 29 to 31.

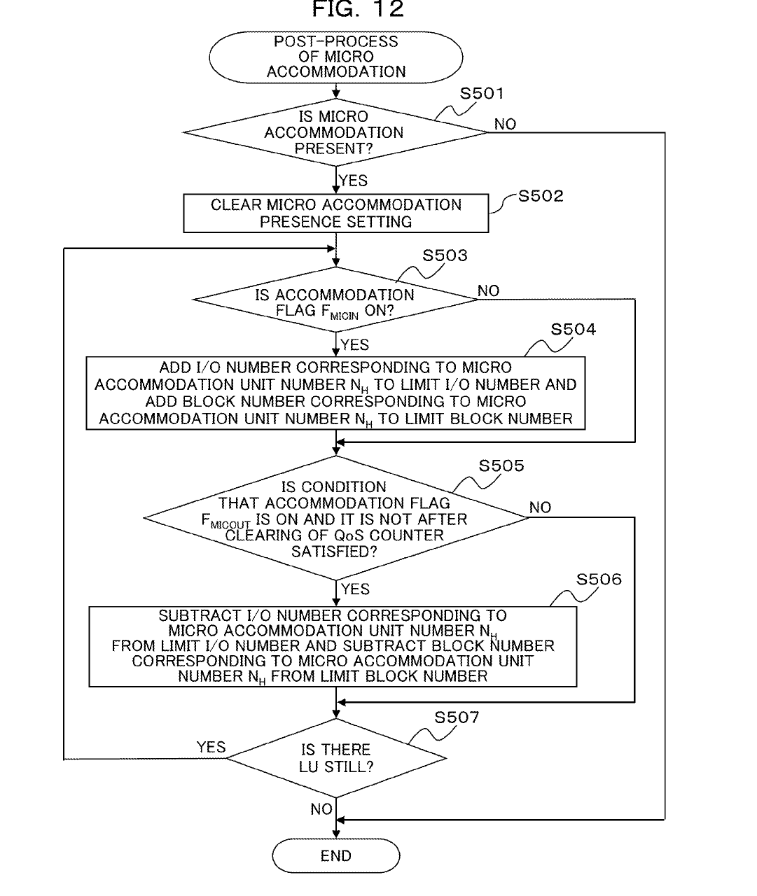

After the QoS I/O startup scheduling process performed by the scheduling unit 506 (see FIG. 6), the post-accommodation processing unit 543 operates in a case where the micro accommodation presence flag (see FIG. 3) of the QoS control area 213 is set to On. The post-accommodation processing unit 543, for every one micro cycle, performs an addition/subtraction process for the limits of the standby LU and the residual LU based on the micro accommodation unit number N_{H} and the accommodation flags F_{MICIN} and F_{MICOUT} and performs the micro bandwidth accommodation at the next N milli-second cycle. However, in this embodiment, as illustrated in FIG. 6, for every one second, a QoS counter relating to the QoS control process is cleared so as to be suppressed not to exceed a numerical range that can be maintained in the memory for the QoS control. In order to respond to the clearing of the QoS counter, the post-accommodation processing unit 543 performs mutually-different processes at the QoS counter clearing timing for every one second and at the other timing. The process performed by the post-accommodation processing unit 543 at each timing will be described later with reference to FIG. 12. The post-accommodation processing unit 543 performs the post-process of micro accommodation as described above in a processing sequence that will be described in detail with reference to FIG. 12.

[2] Operation of this Embodiment

Next, the operation of the storage apparatus 100 according to this embodiment, and more particularly, the processing sequence of the process performed by the storage apparatus 100 according to this embodiment will be described with reference to FIGS. 6 to 20.

[2-1] N Milli-Second Timer Scheduling Process

First, the processing sequence of the N milli-second timer scheduling process performed by the SCSI target control unit 303 according to this embodiment will be described along a flowchart (Steps S101 to S111) illustrated in FIG. 6. Here, for example, N is 10, and the SCSI target control unit 303, for each port, performs the N milli-second timer scheduling process illustrated in FIG. 6 for every 10 milli-seconds. In this way, as described in detail with reference to FIGS. 7 to 9 and FIGS. 11 to 20, the QoS control (QoS I/O startup scheduling), the macro bandwidth accommodation, and the micro bandwidth accommodation are performed.

When the N milli-second timer scheduling process is started up, first, the calculation unit 505 respectively adds the N milli-second I/O number and the N milli-second block number to the limit I/O number and the limit block number that are limits of each port. The port limits of the result of the addition are overwritten and stored in the QoS management table 501 in Step S101. The limit I/O number and the limit block number added to the port limits are the values of N/1000 ( 1/100 in the case of N=10) of the QoS settings (the bandwidth value illustrated in FIG. 4) (see FIG. 5).

In addition, the calculation unit 505 adds the N milli-second I/O number and the N milli-second block number to the limit I/O number and the limit block number that are limits of all the hosts 10. The all-host limits that are the results of the addition are overwritten and stored in the QoS management table 501 in Step S102. The limit I/O number and the limit block number that are added to each host limit value are the values of N/1000 ( 1/100 in the case of N=10) of the QoS settings (bandwidth values illustrated in FIG. 4) (see FIG. 5).

Furthermore, in this embodiment, since the LU is set as the bandwidth accommodation target, the calculation unit 505, for each of all the LUs, performs an all-LU limits adding process illustrated in FIG. 7 in Step S103. Here, the processing sequence of the all-LU limits adding process will be described along a flowchart (Steps S121 to S125) illustrated in FIG. 7.

As illustrated in FIG. 7, the calculation unit 505 adds the N milli-second I/O number and the N milli-second block number to the limit I/O number and the limit block number that are limits of all the LUs. All the host limits that are results of addition are overwritten and stored in the QoS management table 501 in Step S121. The limit I/O number and the limit block number added to each host limit are the values of N/1000 (in the case of N=10, 1/100) of the QoS settings (the bandwidth value illustrated in FIG. 4) (see FIG. 5).

Then, the calculation unit 505 determines whether or not the accommodation flag F_{IN} of each LU is On by referring to the QoS control area 213 in Step S122. In a case where the accommodation flag F_{IN} is On (YES route of Step S122), in other words, in a case where the target LU is an accommodation destination LU receiving the macro bandwidth accommodation, the calculation unit 505 further performs an addition process as below in Step S123.

The calculation unit 505 further adds an I/O number corresponding to the accommodation unit number N_{B} stored in the QoS control area 213 to the limit I/O number that is the limit of the target LU. More specifically, the value of N/1000 of [accommodation unit number N_{B}]×[number of I/Os per unit] is added to the limit I/O number. Similarly, the calculation unit 505 further adds an I/O number corresponding to the accommodation unit number N_{B} of the QoS control area 213 to the limit block number that is the limit of the target LU. More specifically, the value of N/1000 of [accommodation unit number N_{B}]×[number of blocks per unit] is added to the limit block number. The results of the addition are overwritten and stored in the QoS management table 501.

After the process of Step S123 or in a case where the accommodation flag F_{IN} is Off (NO route of Step S122), the calculation unit 505 determines whether or not the accommodation flag F_{OUT} of each LU is On by referring to the QoS control area 213 in Step S124. In a case where the accommodation flag F_{OUT} is On (YES route of Step S124), in other words, the target LU is an accommodation source LU performing the macro bandwidth accommodation, the calculation unit 505 further performs a subtraction process as below in Step S125.

The calculation unit 505 subtracts an I/O number corresponding to the accommodation unit number N_{B} stored in the QoS control area 213 from the limit I/O number that is the limit of the target LU. More specifically, the value of N/1000 of [accommodation unit number N_{B}]×[I/O number per unit] is subtracted from the limit I/O number. Similarly, the calculation unit 505 subtracts a block number corresponding to the accommodation unit number N_{B} stored in the QoS control area 213 from the limit block number that is the limit of the target LU. More specifically, the value of N/1000 of [accommodation unit number N_{B}]×[block number per unit] is subtracted from the limit block number. The results of subtraction is overwritten and stored in the QoS management table 501.

After the process of Step S125 or in a case where the accommodation flag F_{OUT} is Off (NO route of Step S124), the calculation unit 505 ends the all-LU limits adding process.

By performing the all-LU limits adding process (Steps S103 and S121 to S125) as described above every N milli-seconds, the macro bandwidth accommodation is executed every N milli-seconds. In addition, in a case where the host 10 is set as the bandwidth accommodation target, the calculation unit 505, for each of all the hosts, performs an all-host limits adding process similar to the all-LU limit adding process illustrated in FIG. 7 in Step S102.

Meanwhile, when the limit addition process (Steps S101 to S103) is completed, as illustrated in FIG. 6, the calculation process of the busy rate L of all the RAID groups and the accumulation process thereof are performed by the busy rate calculating unit 545, for example, for every 0.5 seconds (one micro cycle) (Step S1041). The calculation sequence of the RAID group busy rate L that is performed by the busy rate calculating unit 545 will be described later with reference to FIGS. 22 to 26.

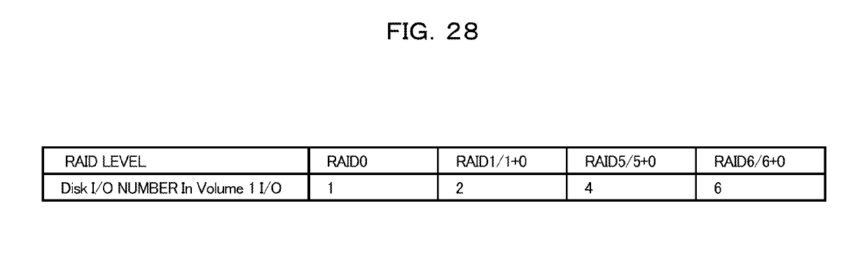

Thereafter, the micro accommodation process performed by the fourth determination unit 541, the accommodation processing unit 542, the fifth determination unit 544, and the busy rate calculating unit 545 is performed, for example, for every 0.5 seconds (one micro cycle) (Step S1042). The micro accommodation process performed by the fourth determination unit 541, the accommodation processing unit 542, the fifth determination unit 544, and the busy rate calculating unit 545 will be described later with reference to FIGS. 29 to 31. In addition, the sequence of the conversion into the busy rate increment that is performed by the busy rate calculating unit 545 and the like, which are included in the micro accommodation process, will be described later with reference to FIGS. 27 and 28.

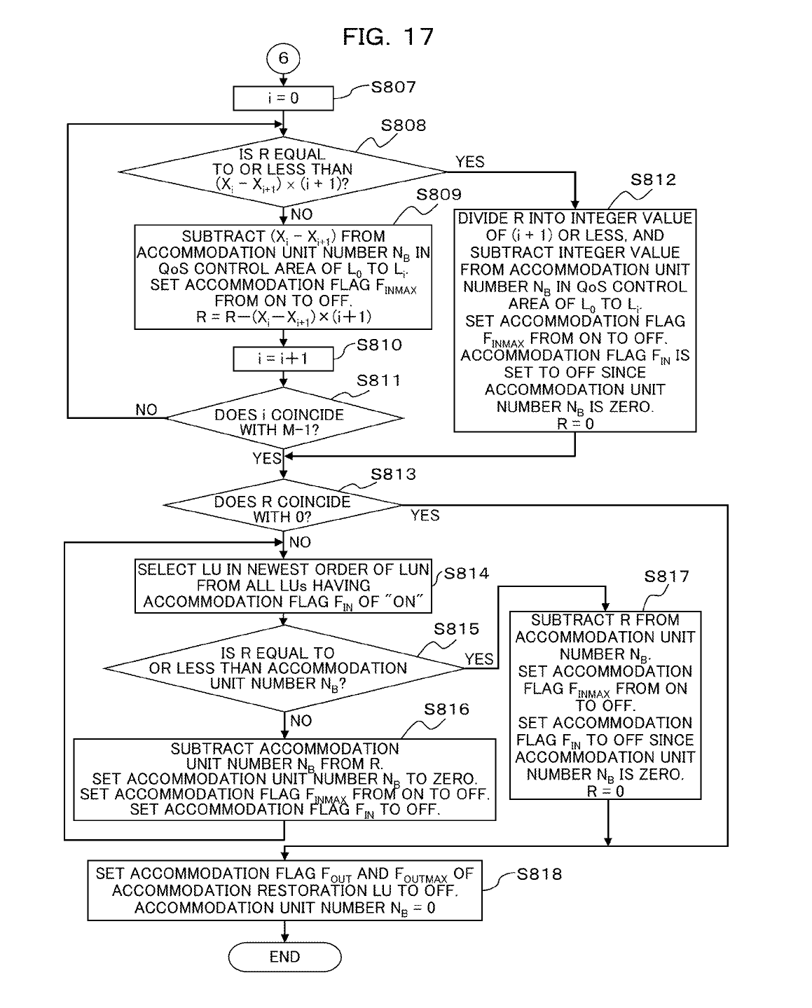

Then, after the macro accommodation one-second checking process performed by the macro accommodation checking unit 510 is performed every one second in Step S105, it is determined whether or not processing bandwidth insufficiency occurs in the accommodation source LU by the third determination unit 531 every N milli-seconds in Step S106. In a case where the processing bandwidth insufficiency occurs in the accommodation source LU (YES route of Step S106), in other words, in a case where an accommodation restoration LU is present, the macro accommodation restoration process is performed by the restoration processing unit 532 in Step S107. The process of Steps S105 to S107 described above correspond to the preprocess of macro accommodation. In addition, the macro accommodation one-second checking process performed by the macro accommodation checking unit 510 will be described later with reference to FIG. 13, and the macro accommodation restoration process performed by the restoration processing unit 532 will be described later with reference to FIGS. 16 and 17.

After the process of Step S107 or in a case where the accommodation restoration LU is not present (NO route of Step S106), the scheduling unit 506 performs the QoS I/O startup scheduling process in Step S108. The QoS I/O startup scheduling process will be described later with reference to FIGS. 8 and 9.

Next, the macro accommodation process performed by the macro accommodation processing unit 520 is performed, for example, every 30 seconds (one macro cycle) in Step S109, and the QoS counter relating to the QoS control process is cleared every one second in Step S110. By clearing the QoS counter, the counter is suppressed not to exceed a numerical range that can be maintained in the memory for the QoS control. Subsequently, the post-process of micro accommodation performed by the post-accommodation processing unit 543 is performed, for example, every 0.5 seconds (one micro cycle) in Step S111, and the process corresponding to one cycle (every N milli-seconds) of the N milli-second timer scheduling process is completed. The macro accommodation process performed by the macro accommodation processing unit 520 will be described later with reference to FIGS. 14 and 15. In addition, the post-process of micro accommodation performed by the post-accommodation processing unit 543 will be described later with reference to FIG. 12.

[2-2] QoS I/O Startup Scheduling Process

Next, the processing sequence of the QoS I/O startup scheduling process (Step S108 illustrated in FIG. 6) performed by the scheduling unit 506 according to this embodiment will be described in detail along a flowchart (Steps S201 to S217) illustrated in FIGS. 8 and 9. In the QoS I/O startup scheduling process, in a case where a command is waiting inside a standby queue arranged for each LU, as described below, the command disposed inside the standby queue is executed based on the limit I/O number and the limit block number of the LU.

The scheduling unit 506 recovers a marked host in Step S201. Subsequently, the scheduling unit 506 recovers a marked LU in step S202. Then, the scheduling unit 506 determines whether or not a next command is present inside the standby queue storing unit 502 in Step S203.

Here, in a case where it is determined that the next command is present inside the standby queue storing unit 502 (YES route of Step S203), the scheduling unit 506 determines whether or not the command number is within the limit I/O number and the limit block number of the port in Step S204. Then, in a case where it is determined that the command number is within the limit I/O number and the limit block number of the port (YES route of Step S204), the scheduling unit 506 determines whether or not the command number is within the limit I/O number and the limit block number of the host in Step S205.

Here, in a case where it is determined that the command number is within the limit I/O number and the limit block number of the host (YES route of Step S205), the scheduling unit 506 determines whether or not the command number is within the limit I/O number and the limit block number of the LU in Step S206. Then, in a case where it is determined that the command number is within the limit I/O number and the limit block number of the LU (YES route of Step S206), the scheduling unit 506 subtracts an I/O number and a block number corresponding to the command from the limits (the limit I/O number and the limit block number) of the port in Step S207.

In addition, the scheduling unit 506 subtracts the I/O number and the block number corresponding to the command from the limits (the limit I/O number and the limit block number) of the host in Step S208. Subsequently, the scheduling unit 506 subtracts the I/O number and the block number corresponding to the command from the limits (the limit I/O number and the limit block number) of the LU in Step S209. Then, the execution unit 507 starts up the command in Step S210. In addition, after starting up the command, the execution unit 507 dequeues the command from the standby queue storing unit 502 in Step S211. After this process, the storage apparatus 100 proceeds to Step S203.

On the other hand, in a case where it is determined that the command number is not within the limit I/O number and the limit block number of the port (NO route of Step S204), the scheduling unit 506 marks the host and the LU in Step S212, and the process ends. In addition, in a case where it is determined that the command number is not within the limit I/O number and the limit block number of the host (NO route of Step S205), the scheduling unit 506 marks the LU in Step S213, and the process proceeds to Step S214.

On the other hand, in a case where it is determined that a next command is not present inside the standby queue storing unit 502 (NO route of Step S203) by the scheduling unit 506, the process proceeds to Step S214. In addition, in a case where it is determined that the command number is not within the limit I/O number and the limit block number of the LU (NO route of Step S206) by the scheduling unit 506, the process proceeds to Step S214.

In Step S214, the scheduling unit 506 sets the next LU. Then, the scheduling unit 506 determines whether or not the next LU is the same as the marked LU in Step S215. Here, in a case where the scheduling unit 506 determines that the next LU is not the same as the marked LU (NO route of Step S215), the process proceeds to Step S203.

On the other hand, in a case where it is determined that the next LU is the same as the marked LU (YES route of Step S215), the scheduling unit 506 sets the next host in Step S216. Subsequently, the scheduling unit 506 determines whether or not the next host is the same as the marked host in Step S217. Here, in a case where it is determined that the next host is not the same as the marked host by the scheduling unit 506 (NO route of Step S217), the process proceeds to Step S202. On the other hand, in a case where it is determined that the next host is the same as the marked host by the scheduling unit 506 (YES route of Step S217), the process ends.

[2-3] Process at Time of Reception of Command

Here, the processing sequence of the command reception process performed by the command reception unit 504 according to this embodiment will be described in detail along a flowchart (Steps S301 to S309) illustrated in FIG. 10. The storage apparatus 100 performs this command reception process, for example, being triggered upon the caption of a command. In the command reception process, when a command is received from the host, as described below, the received command is instantly executed in accordance with the limit I/O number and the limit block number or is enqueued in the standby queue.

As illustrated in FIG. 10, the command reception unit 504 determines whether or not a standby I/O is present between the host that is the issuance source of the received command and the LU in Step S301. Here, in a case where it is determined that there is no standby I/O between the host that is the issuance source and the LUN by the command reception unit 504 (NO route of Step S301), the scheduling unit 506 performs the following process. The scheduling unit 506 determines whether or not the command number is within the limit I/O number and the limit block number of the port in Step S302. Then, in a case where it is determined that the command number is within the limit I/O number and the limit block number of the port (YES route of Step S302), the scheduling unit 506 determines whether or not the command number is within the limit I/O number and the limit block number of the host in Step S303.

Here, in a case where it is determined that the command number is within the limit I/O number and the limit block number of the host (YES route of Step S303), the scheduling unit 506 determines whether or not the command number is within the limit I/O number and the limit block number of the LU in Step S304. Then, in a case where it is determined that the command number is within the limit I/O number and the limit block number of the LU (YES route of Step S304), the scheduling unit 506 subtracts an I/O number and a block number corresponding to the command from the limits (the limit I/O number and the limit block number) of the port in Step S305.

In addition, the scheduling unit 506 subtracts the I/O number and the block number corresponding to the command from the limits (the limit I/O number and the limit block number) of the host in Step S306. Subsequently, the scheduling unit 506 subtracts the I/O number and the block number corresponding to the command from the limits (the limit I/O number and the limit block number) of the LU in Step S307. In addition, the execution unit 507 starts up the command in Step S308. After the process of the Step S308 ends, the storage apparatus 100 ends the process.

On the other hand, in a case where it is determined that a standby I/O is present between the host that is the issuance source of the received command and the LU by the command reception unit 504 (YES route of Step S301), the process proceeds to Step S309. In addition, in a case where it is determined that the command number is not within the limit I/O number and the limit block number of the port by the scheduling unit 506 (NO route of Step S302), the process proceeds to Step S309. Furthermore, in a case where it is determined that the command number is not within the limit I/O number and the limit block number of the host by the scheduling unit 506 (NO route of Step S303), the process proceeds to Step S309. In addition, in a case where it is determined that the command number is not within the limit I/O number and the limit block number of the LU by the scheduling unit 506 (NO route of Step S304), the process proceeds to Step S309. Then, the command reception unit 504, in Step S309, enqueues the command in the standby queue storing unit 502, and the process ends.

[2-4] Micro Accommodation Process

Here, an overview of the micro accommodation process according to this embodiment will be described with reference to FIG. 11. In the example illustrated in FIG. 11, a QoS setting range (bandwidth) for three logical units of LU #0, LU #1, and LU #2 are secured in the bandwidth of the RAID group. In addition, the band upper limit of each of the three logical units of LU #0, LU #1, and LU #2 is set within the QoS setting range. In the example illustrated in FIG. 11, I/O requests for LU #1 and LU #2 arrive at the band upper limits, and an I/O request for LU #0 exceeds the band upper limit. For this reason, the LU #0 is in an insufficient processing bandwidth state, and both the LU #1 and LU #2 are neither in the insufficient processing bandwidth state nor in a processing bandwidth to spare state. Accordingly, conventionally, within the QoS setting range, bandwidth accommodation from the LU #1 and LU #2 to the LU #0 having insufficient processing bandwidth cannot be performed.

In such a state, in a case where there is a the bandwidth to spare of the RAID group to which the LU #0 through the LU #2 belong, as illustrated in FIG. 11, it is preferable to accommodate a band to spare (unassigned band) to the LU #0 having an insufficient processing bandwidth. In this embodiment, when there is no LU having a processing bandwidth to spare, and the accommodation to the accommodation destination LU #0 cannot be performed, in a case where there is a bandwidth to spare in the RAID group to which the destination destination LU #0 belongs, micro bandwidth accommodation from an unassigned band other than the QoS setting range of the RAID group is performed.

[2-4-1] Calculation Sequence of RAID Group Busy Rate and Increment Thereof

First, before the micro accommodation process, the calculation process of the RAID group busy rate L that is performed by the busy rate calculating unit 545 in Step S1041 represented in FIG. 6 will be described with reference to FIGS. 22 to 26 in Sections (A) and (B) described below.

In the basic calculation sequence of the RAID group busy rate L, a busy rate of each disk drive belonging to a RAID group is calculated, and an average value of the busy rates of all the disk drives belonging to the RAID group is calculated as the RAID group busy rate L. The calculation of the busy rate of each disk drive will be described in Section (A) described below, and the calculation of the RAID group busy rate L will be described in Section (B) described below. The busy rate of each disk drive is calculated based on a bandwidth value that is an actual value (maximum value) for each disk drive type.

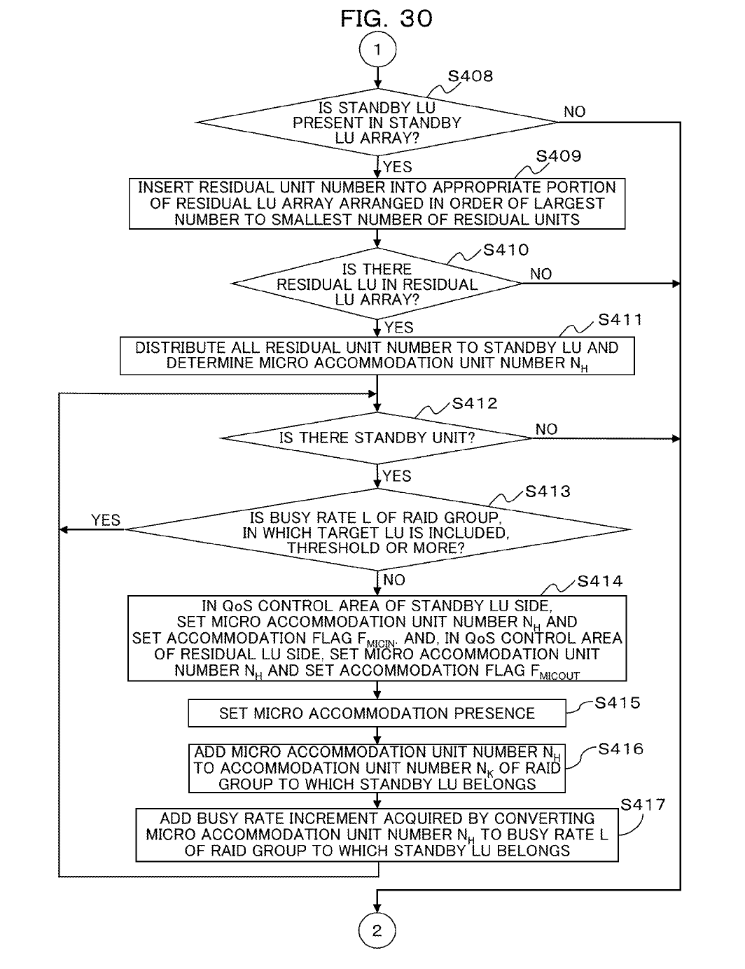

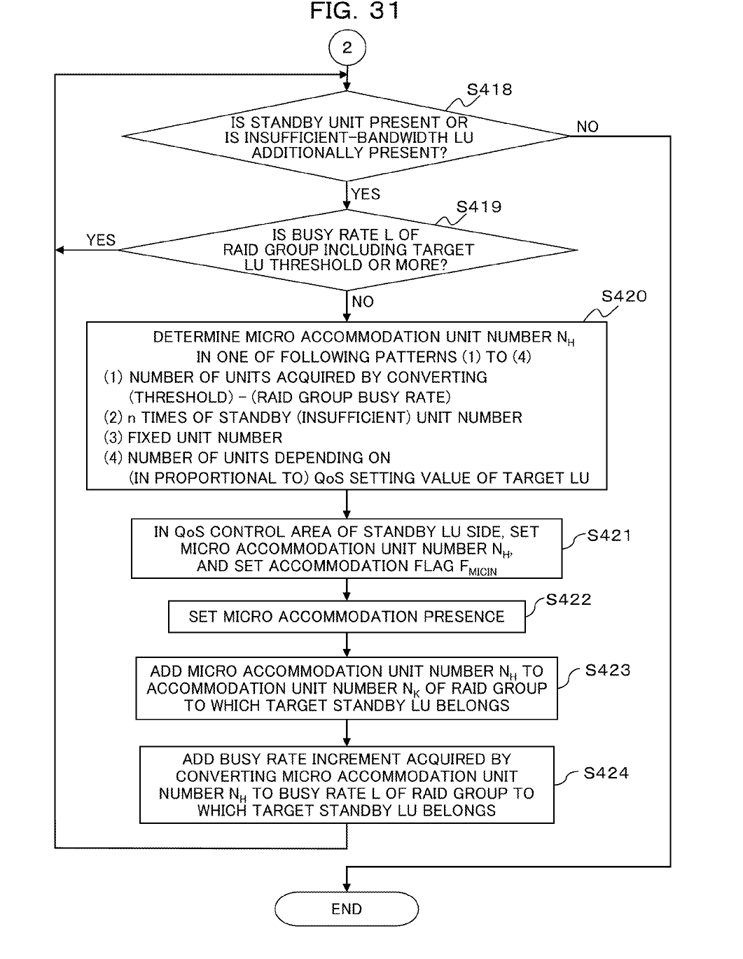

Then, the calculation sequence of a RAID group busy rate increment that is performed by the busy rate calculating unit 545 in the micro accommodation process will be described with reference to FIGS. 27 and 28 in Section (C) described below. The calculation process of the RAID group busy rate increment is performed in Step S417 represented in FIG. 30 and Step S424 represented in FIG. 31.

(A) Disk Drive Busy Rate

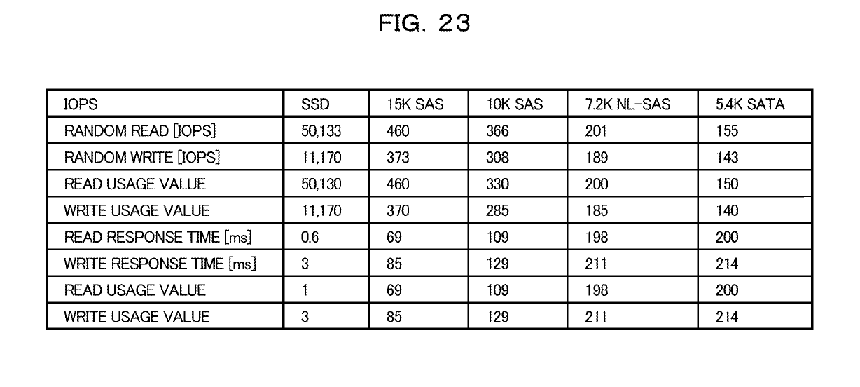

First, an example of specific numerical values used in the description of the calculation of the busy rate is illustrated in FIGS. 22 and 23. FIG. 22 is a diagram that illustrates an average throughput value (sequential bandwidth value) and an average response time at the time of acquisition of the throughput value, which are used for the calculation of the busy rate of a disk drive according to this embodiment, for each disk drive. In addition, FIG. 23 is a diagram that illustrates an average IOPS value (random bandwidth value) and an average response time at the time of acquisition of the average IOPS value, which are used for the calculation of the busy rate of a disk drive according to this embodiment, for each disk drive type.

The disk drive types illustrated in FIGS. 22 to 27 are five types of SSD (Solid State Drive), 15K SAS, 10K SAS, 7.2K NL (near line)-SAS, 5.4K SATA (Serial Advanced Technology Attachment).

Here, in upper four rows illustrated in FIG. 22, average through values [MB/s] are represented. In the first and second rows, actual values (maximum values) [MB/s] of average throughput values of sequential read and sequential write are respectively represented. In the third and fourth rows, a read usage value and a write usage value [MB/s] used for the calculation of the busy rate are respectively represented. As the read usage value and the write usage value, values that are the actual values of the average throughput values of sequential read and sequential write or less are set. In lower four rows in FIG. 22, average response times [ms] corresponding to the average throughput values represented in the upper four rows in FIG. 22 are represented.

In addition, in upper four rows in FIG. 23, average IOPS values are represented. In the first and second rows, actual values (maximum values) of the average IOPS values of random read and random write are respectively represented. Furthermore, in the third and fourth rows, a read usage value and a write usage value [IOPS] used for the calculating the busy rate are represented. As the read usage value and the write usage value, values that are the actual values of the average IOPS values of the random read and the random write or less are set. In lower four rows in FIG. 23, average response times [ms] corresponding to the average IOPS values represented in the upper four rows in FIG. 23 are represented.

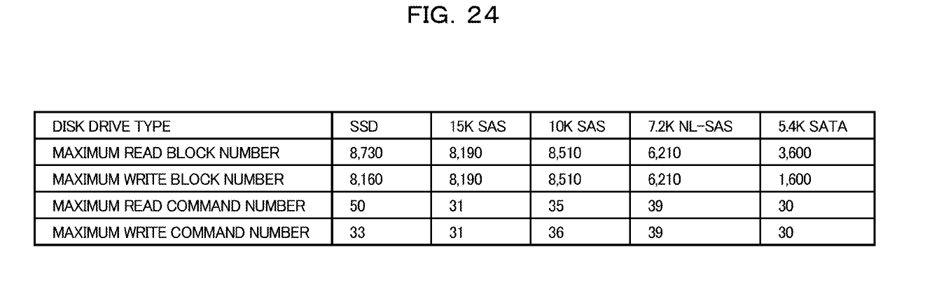

Based on the read usage value and the write usage value represented in FIGS. 22 and 23, first, a maximum read block number, a maximum write block number, a maximum read command number, and a maximum write command number as illustrated in FIG. 24 are calculated for each disk drive type. The maximum read block number and the maximum write block number are the number of blocks during average execution in a case where the throughputs of read and write are processed in an average response time and are calculated as blow. In addition, the maximum read command number and the maximum write command number are the number of commands during average execution in a case where the IOPS of read and write are processed in the average response time and are calculated as below.

[maximum read block number]=[value acquired by converting the throughput value of sequential read per 1 ms into the number of blocks]×[average response time of sequential read]

[maximum write block number]=[value acquired by converting the throughput value of sequential write per 1 ms into the number of blocks]×[average response time of sequential write]

[maximum read command number]=[the number of commands of random read per 1 ms]×[average response time of random read]

[maximum write command number]=[the number of commands of random write per 1 ms]×[average response time of random write]

For example, the maximum read block number of the SSD is calculated as below. The throughput value (read usage value) of sequential read per 1 ms is 485/1000. By converting the throughput value 485/1000 per 1 ms into the number of blocks, 485/1000×2000 is acquired. In addition, the average response time (read usage value) of the sequential read is 9. Accordingly, the maximum read block number of the SSD is 485/1000×2000×9=8730.

In addition, for example, the maximum write command number of the SSD is calculated as below. The number of commands (write usage value) of random write per 1 ms is 11170/1000. In addition, the average response time (write usage value) of the random write is 3. Accordingly, the maximum write command number of the SSD is 11170/1000×3≈33.

In addition, the maximum read command number and the maximum write command number are the number of queues of the disk drive. In this embodiment, in a case where the disk drive type is the SSD, the 15K SAS, or the 10K SAS, “40” may be used as the upper limits of the maximum read command number and the maximum write command number. On the other hand, in a case where the disk drive type is the NL-SAS or the 5.4K SATA, “30” may be used as the upper limits of the maximum read command number and the maximum write command number.

Then, the busy rate calculating unit 545 acquires the following information (1) to (4) of each disk drive at timing when the busy rate of each disk drive is calculated.

(1) number of read commands that are in the middle of execution

(2) all the number of blocks of read commands that are in the middle of execution

(3) number of write commands that are in the middle of execution

(4) all the number of blocks of write commands that are in the middle of execution

Next, the busy rate calculating unit 545 calculates busy rate information (a) to (d) as below for each of the information (1) to (4).

[busy rate based on the read block number]=[number (the information (2) described above) of read blocks that are in the middle of execution]/[maximum read block number (see the first row in FIG. 24)] (a)

[busy rate based on the write block number]=[number (the information (4) described above) of write blocks that are in the middle of execution]/[maximum write block number (see the second row in FIG. 24)] (b)

[busy rate based on the read command number]=[number (the information (1) described above) of read commands that are in the middle of execution]/[maximum read command number (see the third row in FIG. 24)] (c)

[busy rate based on the write command number]=[number (the information (3) described above) of write commands that are in the middle of execution]/[maximum write command number (see the fourth row in FIG. 24)] (d)

The busy rate calculating unit 545 performs the calculation process of the busy rate information (a) to (d) described above, for example, for 0.5 seconds that is a micro bandwidth accommodation period at the interval of N milliseconds. In case of N=10, the busy rate is acquired by averaging calculation results corresponding to 50 times, and a determination of the bandwidth accommodation can be made based on the acquired busy rate. On the other hand, in case of N=100, the busy rate is acquired by averaging calculation results corresponding to 5 times, and a determination of the bandwidth accommodation can be made based on the acquired busy rate.

Next, the busy rate calculating unit 545 acquires sequential/random ratio information (e) to (l), for example, for 0.5 seconds that is a micro bandwidth accommodation checking period. The sequential, for example, is a command having a size of 128 blocks or more, and the random, for example, is a command having a size less than 128 blocks. The information (e) to (l) acquired here is as below.

(e) Sequential read command number (a block size of 128 or more)

(f) Sequential write command number (a block size of 128 or more)

(g) Random read command number (a block size less than 128)

(h) Random write command number (a block size less than 128)

(i) Sequential read block number (a block size of 128 or more)

(j) Sequential write block number (a block size of 128 or more)

(k) Random read block number (a block size less than 128)

(l) Random write block number (a block size less than 128)

The busy rate calculating unit 545, for each disk drive, calculates the busy rate of the disk drive for 0.5 seconds by using the following equation.

[Disk drive busy rate]=(a)×((i)/((i)+(j)+(k)+(l)))+(b)×((j)/((i)+(j)+(k)+(l)))+(c)×((g)/((e)+(f)+(g)+(h)))+(d)×((h)/((e)+(f)+(g)+(h)))

(B) RAID Group Busy Rate

When the disk drive busy rate is calculated for each disk drive as described above, the busy rate calculating unit 545 calculates the RAID group busy rate L based on the calculated disk drive busy rates.

At this time, the RAID group busy rate L, as in the following equation, is an average (average busy rate) of the disk drive busy rates calculated for all the disk drives that configure the RAID group. Since a difference between RAID levels is reflected on the command numbers for all the disk drives, it is assumed that there is no difference in the method of calculating the busy rate for each RAID level. Hereinafter, disk drives configuring a RAID group may be referred to as “configuring disk drives”.

[RAID group busy rate L]=[Sum of busy rates of disk drives calculated for all the disk drives configuring the RAID group]/[Number of configuring disk drives]

In addition, in a case where disk drives of mutually-different types are included in a plurality of disk drives that configure the RAID group, the busy rate calculating unit 545 may calculate the RAID group busy rate L by multiplying the busy rate of each disk drive by a coefficient according to each of the types by using the following equation. The bandwidth of the RAID group is largely depends on the bandwidth of a disk drive having a low actual bandwidth. For this reason, the coefficient, as represented as the disk drive mixture coefficient in FIG. 25, is set to increase as the bandwidth of the disk drive decreases.

[RAID group busy rate L]=[Sum of [Busy rate calculated for each of all the disk drives configuring the RAID group]×[Disk drive mixture coefficient of the disk drive according to the type of each disk drive]]/[Sum of the disk drive mixture coefficients respectively multiplied by the busy rates of the disk drives]

In addition, also in a case where a plurality of RAID groups configure an automatic hierarchization pool (flexible tiered pool), the RAID group busy rate L can be calculated as an average of busy rates of all the disk drives belonging to all the RAID groups. At that time, it is preferable to assign a weighting factor that is larger as the speed of the RAID group is higher. For this reason, the busy rate calculating unit 545, as in the following equation, may perform weighting (multiplication using a weighting coefficient) according to the type of the disk drive belonging to the RAID group for the busy rate of each RAID group. At this time, the weighting factor, as represented as the flexible tiered weighing coefficient in FIG. 26, is set to be larger as the processing speed of the disk drive is higher.

[RAID group busy rate L]=[Sum of [Average busy rate of the disk drives belonging to each RAID group]×[Flexible tiered weighting coefficient according to the type of the disk drives belonging to each RAID group]]/[Sum of [Number of the disk drives belonging to each RAID group]×[Flexible tiered weighting coefficient according to the type of the disk drives belonging to each RAID group]]

As described above, in the flexible tiered case, by performing the above-described calculation for all the disk drives of all the RAID groups configuring the pool, the RAID group busy rate L is acquired. However, in a case where a CM responsible for the management of the RAID groups configuring the pool is divided into two CMs 200a and 200b, a problem is caused. Basically, the busy rate is maintained by only one CM, and bandwidth accommodation is enabled by the one CM. As the one CM, a CM managing a highest-speed RAID group is selected, and, in a case where such a CM is not present, a CM having a larger bandwidth is selected. In the other CM (a CM disposed of the other side) not maintaining the busy rate, bandwidth accommodation is not performed.

(C) RAID Group Busy Rate Increment

Next, the sequence of the conversion into the busy rate increment and the like that are performed by the busy rate calculating unit 545 will be described with reference to FIGS. 27 and 28.

In this embodiment, the bandwidth accommodation for each LU (volume) is performed for every micro cycle (for example, 0.5 seconds). At this time, a RAID group, for example, of which the busy rate L is less than a predetermined value (for example, 80%) receives bandwidth accommodation for the next micro cycle, whereby the busy rate L thereof is predicted to increase. In addition, in a case where the bandwidth accommodation is performed for a plurality of LUs (volumes) without an increase in the busy rate L being considered, the busy rate L is predicted to jump up instantly.

Thus, in this embodiment, when bandwidth accommodation is performed for the LU, the bandwidth accommodation is performed while an increment relating to a rise (increase) in the busy rate L according to the amount of the bandwidth accommodation is calculated by the busy rate calculating unit 545. In a case where a plurality of accommodation destination LUs are present, the bandwidth accommodation is performed in a preferential order (for example, in order of largest to smallest number of standby units). At that time, by reflecting the busy rate increment after the bandwidth accommodation on the busy rate L, the execution of the bandwidth accommodation causing the busy rate L to exceed far over a predetermined threshold is suppressed.

Hereinafter, the sequence of the conversion into the busy rate increment relating to the amount of an increase in the RAID group busy rate L according to the amount of the bandwidth accommodation to the LU will be described.

First, the busy rate calculating unit 545 acquires a maximum bandwidth value of the RAID group for 0.5 seconds. In case of a thin provisioning pool, a sum of maximum bandwidth values acquired for the RAID groups included in the pool is acquired. On the other hand, in case of a flexible tiered pool, a sum of values acquired by multiplying the maximum bandwidth values acquired for tiers by weighting coefficients (see FIG. 26) of the disk drive types is acquired.

As the number of blocks and the number of commands (maximum bandwidth value) that can be processed for 0.5 seconds by each disk drive, values as illustrated in FIG. 27 are acquired. In FIG. 27, “the number of blocks/0.5 seconds” and “the number of commands/0.5 seconds” calculated for each disk drive type are represented. Here, the maximum bandwidth values are acquired based on a write operation having a low bandwidth.

In the example illustrated in FIG. 27, in a field of the disk drive type “SSD”, an average throughput value of 340 MB/s (see the write usage value of the SSD illustrated in FIG. 22) of sequential write is written. By multiplying the average throughput value of 340 by 2048 and 0.5, the average throughput value 340 of the sequential write is converted into a value of 348160 as “the number of blocks/0.5 seconds”. Similarly, in the example illustrated in FIG. 27, in a field of the disk drive type “SSD”, an average IOPS value of random write that is 11170 (see the write usage value of the SSD illustrated in FIG. 23) is written. By multiplying the average IOPS value of 11170 by 0.5, the average IOPS value of the random write as 11170 is converted into a value of 5585 as “the number of commands/0.5 seconds”.

In addition, the number of disk drive I/Os for each RAID level for the volume 1 I/O (LU 1 I/O), for example, is as illustrated in FIG. 28.

Based on the maximum bandwidth value of each disk drive for 0.5 seconds as described above, the number of blocks and the number of commands of the RAID group that can be processed for 0.5 seconds, normally, are calculated by using the following equations (101) and (102). Here, it is assumed that the types of the disk drives are the same.

[Number of RAID group blocks/0.5 seconds]=[Sum of the number of blocks of the configured disk drives/0.5 seconds]×[Number of I/Os of disk drives for each RAID level] (101)

[Number of RAID group commands/0.5 seconds]=[Sum of the numbers of commands of the configured disk drives/0.5 seconds]×[Number of I/Os of disk drives for each RAID level] (102)

In addition, in a case where the types of the disk drives that configure the RAID group are different from each other, the bandwidth of the RAID group depends on the bandwidth of a disk drive having a low actual bandwidth, and accordingly, the number of blocks and the number of commands of the RAID group that can be processed for 0.5 seconds are calculated as in the following equations (103) and (104).

[Number of RAID group blocks/0.5 seconds]=[Number of blocks of a disk drive having a lowest bandwidth among configuring disk drives/0.5 seconds]×[Number of the configuring disk drives]×[the number of disk drive I/Os for each RAID level] (103)

[Number of RAID group commands/0.5 seconds]=[Number of commands of a disk drive having a lowest bandwidth among configuring disk drives/0.5 seconds]×[Number of the configuring disk drives]×[the number of disk drive I/Os for each RAID level] (104)

In addition, in case of a flexible tiered pool, the bandwidth of the pool, as represented in the following equations (105) and (106), is calculated as a sum of values acquired by multiplying [Number of blocks/0.5 seconds] or [Number of commands/0.5 seconds] of each RAID group configuring the pool by flexible tiered weighting coefficients (see FIG. 26) according to the types of disk drives.

[Number of flexible tiered pool blocks/0.5 seconds]=Sum of [[Number of blocks of the RAID group configuring the pool/0.5 seconds]×[Number of disk drive I/Os for each RAID level]×[Flexible tiered weighting coefficient for each disk drive type]] (105)

[Number of flexible tiered pool commands/0.5 seconds]=Sum of [[Number of commands of the RAID group configuring the pool/0.5 seconds]×[Number of disk drive I/Os for each RAID level]×[Flexible tiered weighting coefficient for each disk drive type]] (106)

In this embodiment, the busy rate calculating unit 545, as in the following equations (107) and (108), calculates a busy rate increment of the RAID group according to the bandwidth accommodation as a value of a fraction having the following denominator and numerator. In other words, the denominator, as calculated as in the equations (101) to (104) described above, is the number of RAID group blocks per 0.5 seconds or the number of RAID group commands per 0.5 seconds. In addition, as the numerator, a value acquired by multiplying the number of blocks or the number of commands (bandwidth accommodation amount) receiving the bandwidth accommodation by the disk drive I/O number for each RAID level is used.

[RAID group busy rate increment]=a larger value of [[Number of accommodated blocks]×[Number of disk drive I/Os for each RAID level]/[Number of RAID group blocks/0.5 seconds]] and [[Number of accommodated commands]×[Number of disk drive I/Os for each RAID level]/[Number of RAID group commands/0.5 seconds]] (107)

In addition, in case of a flexible tiered pool, the busy rate increment of the RAID group according to the bandwidth accommodation is calculated as in the following equation (108).

[RAID group busy rate increment]=a larger value of [[Number of accommodated blocks]×[Number of disk drive I/Os for each RAID level]×[Flexible tiered weighting coefficient for each disk drive type]/[Number of RAID group blocks/0.5 seconds]] and [[Number of accommodated commands]×[Number of disk drive I/Os for each RAID level]×[Flexible tiered weighting coefficient for each disk drive type]/[Number of RAID group commands/0.5 seconds]] (108)

[2-4-2] Micro Accommodation Process

Next, the micro accommodation process (Step S1042 illustrated in FIG. 6) performed by the micro accommodation processing unit 540 (the fourth determination unit 541 and the accommodation processing unit 542) according to this embodiment will be described along a flowchart (Steps S401 to S424) illustrated in FIGS. 29 to 31. The micro accommodation process is performed every one micro cycle (for example 0.5 seconds=500 milli-seconds) before the QoS I/O startup scheduling process performed by the scheduling unit 506 while the N milli-second timer scheduling process illustrated in FIG. 6 is performed for every N milli-seconds. The process of Steps S401 to S407 is illustrated in FIG. 29, and the process of Steps S408 to S417 is illustrated in FIG. 30, and the process of Steps S418 to S424 is illustrated in FIG. 31.

As illustrated in FIG. 11, when starting to operate for every 0.5 seconds, the micro accommodation processing unit 540, first, for each RAID group, clears the RAID group accommodation unit number N_{K} of the table area 214 to be zero (Step S401). In addition, in the micro accommodation processing unit 540, for each LU, the accommodation flags F_{MICIN} and F_{MICOUT} stored in the QoS control area 213 are cleared to be in the Off state in Step S402. In addition, in the micro accommodation processing unit 540, for each LU, the micro accommodation unit number N_{H} stored in the QoS control area 213 is cleared to be zero in Step S403. In this way, all the information relating to the micro bandwidth accommodation process of the previous time is cleared. Accordingly, the micro bandwidth accommodation with an accommodation amount according to the value of the micro accommodation unit number N_{H} is performed only once (one micro cycle).

Thereafter, the fourth determination unit 541, for each LU, determines whether or not there is an I/O request that is in the standby state for the LU (target LU) (Step S404). Then, in a case where there is an I/O request that is in the standby state (the YES route of Step S404), the fifth determination unit 544 determines the presence/absence of a bandwidth to spare in the RAID group including the target LU (accommodation destination LU) (Step S405). At this time, the fifth determination unit 544 determines whether or not the busy rate L for the RAID group, which is calculated by the busy rate calculating unit 545 and is stored in the table area 214, is a predetermined value (for example, 80%) or more.

In a case where the busy rate L for the RAID group is less than the predetermined value (the NO route of Step S405), it is determined that there is a bandwidth to spare in the RAID group, and the accommodation processing unit 542 inserts the target LU of this time into an appropriate position in the standby LU array (list) (Step S406). The standby LU array is acquired by arranging accommodation destination LUs each having an I/O request that is in the standby state in order of the highest to lowest priority level and then arranging the destination LUs in order of largest to smallest amounts of I/O requests (number of standby units) that are in the standby state. The standby unit number is a value converted from the standby I/O number N_{C} and the standby block number N_{D} stored in the QoS control area 213. The standby LU array (list) for the micro bandwidth accommodation, for example, is generated inside the QoS control area 213 and stores the LUN specifying a LU and the standby unit number of the LU in association with each other. In this embodiment, the “accommodation LU number in one cycle” in the micro bandwidth accommodation, for example, is set to 4 LUs, and accordingly, four is sufficient as the number of elements of the standby LU array.

After the process of Step S406 or in a case where there is no I/O request for the target LU (NO route of Step S404), or in a case where the busy rate L is the predetermined value or more and, it is determined that there is no bandwidth to spare in the RAID group (the YES route of Step S405), the accommodation processing unit 542 performs the process of Step S407. In other words, the accommodation processing unit 542 determines whether or not the determination of the presence/absence of an I/O request that is in the standby state has been made for all the LUs (Step S407). In a case where the determination of the presence/absence of the I/O request that is in the standby state has not been made for all the LUs (the NO route of Step S407), the micro accommodation processing unit 540 returns the process to the process of Step S402. On the other hand, in a case where the determination of a unit number has been performed for all the LUs (YES route of Step S407), the accommodation processing unit 542 determines whether or not a standby LU is present in the standby LU array for the micro bandwidth accommodation in Step S408.

In a case where a standby LU is present in the standby LU array (the YES route of Step S408), the accommodation processing unit 542 inserts the target LU at an appropriate position in the residual LU array (list) (Step S409). The residual LU array is acquired by arranging accommodation source LUs each having a bandwidth to spare in order of largest to smallest bandwidth amount to spare (the number of residual units). The residual LU array (list) for the micro bandwidth accommodation, for example, is generated inside the QoS control area 213 and stores the LUN specifying a LU and the residual unit number of the LU in association with each other. As the residual unit number of the target LU, the residual unit number N_{I} stored in the QoS control area 213 is read and used.

Thereafter, the accommodation processing unit 542 determines whether or not there is a residual LU in the residual LU array used for micro bandwidth accommodation (Step S410). In a case where there is a residual LU in the residual LU array (the YES route of Step S410), the accommodation processing unit 542, based on the standby LU array and the residual LU array, distributes all the residual unit number (sum) to standby LUs and determines the micro accommodation unit number N_{H} for each standby LU (Step S411).

Then, the accommodation processing unit 542 checks the presence/absence of a standby unit (Step S412). In a case where there is a standby unit (the YES route of Step S412), similar to Step S405, the fifth determination unit 544 determines whether or not there is a bandwidth to spare in the RAID group including the target LU (accommodation destination LU) (Step S413). In a case where the busy rate L for the RAID group is a predetermined value or more, and it is determined that there is no bandwidth to spare in the RAID group (the YES route of Step S413), the accommodation processing unit 542 returns the process to the process of Step S412.

On the other hand, in a case where the busy rate L for the RAID group is less than the predetermined value (the NO route of Step S413), it is determined that there is a bandwidth to spare in the RAID group, and the accommodation processing unit 542 performs the process of Step S414 such that micro bandwidth accommodation from the residual LU to the standby LU is performed. In other words, the accommodation processing unit 542, in the QoS control area 213 of the standby LU that receives the bandwidth accommodation, sets the micro accommodation unit number N_{H} accommodating from the residual LU and sets the accommodation flag F_{MICIN} representing that the standby LU receives the micro bandwidth accommodation to On. In addition, the accommodation processing unit 542, in the QoS control area 213 of the residual LU of the determined combination, sets the micro accommodation unit number N_{H} accommodating to the standby LU and sets the accommodation flag F_{MICOUT} representing that the residual LU performs micro bandwidth accommodation to On (Step S414). Furthermore, a standby LU and a residual LU of which the standby state and the residual state can be resolved by the bandwidth accommodation are respectively removed from the standby LU array and the residual LU array.

In addition, in a case where at least one set of a combination of a standby LU and a residual LU for which the micro bandwidth accommodation is performed is determined, the accommodation processing unit 542 sets the micro accommodation presence flag of the QoS control area 213 to On (Step S415) and notifies the post-accommodation processing unit 543 of the performing of the micro bandwidth accommodation. Then, the accommodation processing unit 542 adds the micro accommodation unit number N_{H} determined in Step S411 to the accommodation unit number N_{K} (table area 214) of the RAID group to which the standby LU receiving the bandwidth accommodation (Step S416) belongs.

Furthermore, the busy rate calculating unit 545 converts the micro accommodation unit number N_{H} (bandwidth accommodation amount) determined in Step S411 into an increment (busy rate increment) of the RAID group busy rate L. The conversion technique is as described in Section (C) described above. The busy rate calculating unit 545 adds the converted busy rate increment to the busy rate L for the RAID group to which the standby LU that is the bandwidth accommodation target belongs in the table area 214 (Step S417). Thereafter, the micro accommodation processing unit 540 returns the process to the process of Step S412.

In a case where “No” is determined in each of Steps S408, S410, and S412, the accommodation processing unit 542 determines whether a standby unit is present, or whether a LU having an insufficient bandwidth is additionally present (Step S418). In a case where neither a standby unit nor an insufficient-bandwidth LU is present (the NO route of Step S418), the micro accommodation processing unit 540 ends the micro accommodation process.

On the other hand, in a case where a standby unit or an insufficient-bandwidth LU is present, a state is considered in which a residual LU capable of performing micro bandwidth accommodation for the accommodation destination LU is not present. In such a state, according to this embodiment, when there is a bandwidth to spare in the RAID group to which the standby LU (insufficient-bandwidth LU) belongs, micro bandwidth accommodation is performed from an unassigned band other than the LU band in the RAID group.

Thus, in this embodiment, in a case where a standby unit or an insufficient-bandwidth LU is present (the YES route of Step S418), similar to Step S405, the fifth determination unit 544 determines the presence/absence of a bandwidth to spare in the RAID group including the standby LU (standby unit) (Step S419). In a case where the busy rate L for the RAID group is the predetermined value or more, and it is determined that there is no bandwidth to spare in the RAID group (the YES route of Step S419), the accommodation processing unit 542 returns the process to the process of Step S418.

On the other hand, in a case where the busy rate L for the RAID group is less than the predetermined value (the NO route of Step S419), it is determined that there is a bandwidth to spare in the RAID group. Then, the accommodation processing unit 542 performs the process of Steps S420 and S421 such that micro bandwidth accommodation is performed from an unassigned band (a band having a bandwidth to spare) other than the LU band in the RAID group to the standby LU.

At this time, the accommodation processing unit 542 determines the micro accommodation unit number N_{H} to be accommodated from the unassigned band of the RAID group to the standby LU by using one of the four patterns described above (Step S420). Then, the accommodation processing unit 542 sets the micro accommodation unit number N_{H} to be accommodated from the residual LU in the QoS control area 213 of the standby LU receiving the bandwidth accommodation and sets the accommodation flag F_{MICIN} representing that the standby LU receives the micro bandwidth accommodation to On (Step S421). In addition, a standby LU of which the standby state is resolved by the bandwidth accommodation is removed from the standby LU array.

In addition, the accommodation processing unit 542 sets the micro accommodation presence flag of the QoS control area 213 to On (Step S422) and notifies the post-accommodation processing unit 543 that the micro bandwidth accommodation is performed. Then, the accommodation processing unit 542 adds the micro accommodation unit number N_{H} determined in Step S420 to the accommodation unit number N_{K} (the table area 214) of the RAID group to which the standby LU receiving the bandwidth accommodation belongs (Step S423).

Furthermore, similar to Step S417, the busy rate calculating unit 545 converts the micro accommodation unit number N_{H} determined in Step S420 into an increment of the RAID group busy rate L (busy rate increment). Then, the busy rate calculating unit 545 adds the converted busy rate increment to the busy rate L for the RAID group to which the standby LU that is a bandwidth accommodation target belongs in the table area 214 (Step S424). Thereafter, the micro accommodation processing unit 540 returns the process to the process of Step S418.

[2-5] Post-Process of Micro Accommodation

Next, the processing sequence of the post-process of micro accommodation (Step S111 illustrated in FIG. 6) performed by the post-accommodation processing unit 543 according to this embodiment will be described along a flowchart (Steps S501 to S507) illustrated in FIG. 12. The post-process of micro accommodation is performed every one micro cycle (0.5 seconds) after the QoS I/O startup scheduling process performed by the scheduling unit 506 while the N milli-second timer scheduling process illustrated in FIG. 6 is performed every N milli-seconds. Particularly, the post-process of micro accommodation, as illustrated in FIG. 6, is performed in a final step of Step S111 of the N milli-second timer scheduling process after the QoS I/O startup scheduling process and the macro accommodation process are performed, and the QoS counter is cleared every one second.

As illustrated in FIG. 12, the post-accommodation processing unit 543, first, determines whether or not the micro accommodation presence flag stored in the QoS control area 213 is On in Step S501. In a case where the micro accommodation flag is Off (NO route of Step S501), the post-accommodation processing unit 543 completes the post-process of micro accommodation without performing any process.

On the other hand, in a case where the micro accommodation presence flag is On (YES route of Step S501), the post-accommodation processing unit 543 sets the micro accommodation flag stored in the QoS control area 213 to Off (after the setting of the micro accommodation presence is cleared) in Step S502. Thereafter, the post-accommodation processing unit 543, for each LU, determines whether or not the accommodation flag F_{MICIN} is On in Step S503.

In a case where the accommodation flag F_{MICIN} is On (YES route of Step S503), in other words, the target LU is a standby LU, the post-accommodation processing unit 543 adds an I/O number corresponding to the micro accommodation unit number N_{H} to the limit I/O number of the LU. In addition, the post-accommodation processing unit 543 adds a block number corresponding to the micro accommodation unit number N_{H} to the limit block number of the LU in Step S504.

After the process of Step S504 or in a case where the accommodation flag F_{MICIN} is Off (NO route of Step S503), the post-accommodation processing unit 543 determines, for each LU, whether or not a predetermined determination condition described below is satisfied in Step S505. Here, the predetermined determination condition is a condition that the accommodation flag F_{MICOUT} of the target LU is ON, and the timing is not after the clearing of the QoS counter performed every one second.

In a case where the predetermined determination condition is satisfied (YES route of Step S505), in other words, the timing is not after the clearing of the QoS counter performed every one second, and the target LU is a residual LU, the post-accommodation processing unit 543 performs a subtraction process described below in Step S506. The post-accommodation processing unit 543 subtracts an I/O number corresponding to the micro accommodation unit number N_{H} from the limit I/O number of the LU and subtracts a block number corresponding to the micro accommodation unit number N_{H} from the limit block number of the LU.

In a case where the predetermined determination condition is not satisfied (NO route of Step S505), in other words, in a case where the accommodation flag F_{MICOUT} of the target LU is Off, and the timing is after the clearing of the QoS counter performed every one second, the post-accommodation processing unit 543 proceeds to the process of Step S507 without performing the subtraction process of Step S506. The reason for this is that, in a case where the timing is after the clearing of the QoS counter performed every one second, the QoS counter is cleared, and accordingly, the subtraction process does not need to be performed.

After the process of Step S506 or in a case where “No” is determined in Step S505, the post-accommodation processing unit 543 determines whether or not a LU that is the determination target is still present in Step S507. In a case where the LU that is the determination target is still present (YES route of Step S507), the post-accommodation processing unit 543 returns the process to Step S503. On the other hand, in a case where no LU that is the determination target is present (NO route of Step S507), the post-accommodation processing unit 543 completes the post-process of micro accommodation.

[2-6] Macro Accommodation One-Second Checking Process

Next, the macro accommodation one-second checking process (Step S105 illustrated in FIG. 6) performed by the macro accommodation checking unit 510 according to this embodiment will be described along a flowchart (Steps S601 to S608) illustrated in FIG. 13. In the macro accommodation one-second checking process, a minimum residual unit number N_{E} and a minimum standby unit number N_{F} that are information for determining whether or not the macro bandwidth accommodation is performed by using the first and second determination units 521 and 522 are acquired. In the macro accommodation one-second checking process, for example, is performed every one second while the N milli-second timer scheduling process illustrated in FIG. 6 is performed every N milli-seconds.

As illustrated in FIG. 13, the macro accommodation checking unit 510, first, as a default value of the return value, stores “FALSE” in the QoS control area 213 and the like in Step S601. Here, the return value “FALSE” is information representing that the accommodation restoration LU returning an accommodation amount through the macro bandwidth accommodation is not present. Thereafter, the macro accommodation checking unit 510 performs the following process (Steps S602 to S608) for each LU.

The macro accommodation checking unit 510 determines whether the accommodation flag F_{OUT} of the target LU is On and a standby I/O is present in the target LU, in other words, whether the target LU is an accommodation source LU and is an accommodation restoration LU in which the processing bandwidth insufficiency occurs in Step S602.

In a case where the target LU is an accommodation restoration LU (YES route of Step S602), the macro accommodation checking unit 510 stores “TRUE” as a return value in the QoS control area 213 and the like in Step S608. Here, the return value “TRUE” is information representing that an accommodation restoration LU is present. Thereafter, the macro accommodation checking unit 510 proceeds to the process of Step S607.

In a case where the target LU is not an accommodation restoration LU (NO route of Step S602), the second acquisition unit 512 acquires the current residual unit number N_{I} of the LU. The residual unit number N_{I} of each LU is acquired by referring to the residual unit number N_{I} of each LU that is stored in the QoS control area 213. Then, the second acquisition unit 512 compares the residual unit number N_{I} acquired this time and the value (the minimum residual unit number until the current time point) N_{E} stored in the QoS control area 213 with each other in Step S603.

In a case where the residual unit number N_{I} acquired this time is less than the value N_{E} (YES route of Step S603), the second acquisition unit 512 replaces the value N_{E} with the residual unit number N_{I} acquired this time in Step S604.

After the process of Step S604 or in a case where the residual unit number N_{I} acquired this time is the value N_{E} or more (NO route of Step S603), the first acquisition unit 511 acquires the current standby unit number of the LU. The standby unit number of each LU, as described above, is a value converted from the standby I/O number N_{C} and the standby block number N_{D} of the target LU. Then, the first acquisition unit 511 compares the standby unit number acquired this time and the value (the minimum standby unit number until the current time point) N_{F} stored in the QoS control area 213 with each other in Step S605.

In a case where the standby unit number acquired this time is less than the value N_{F} (YES route of Step S605), the first acquisition unit 511 replaces the value N_{F} with the standby unit number acquired this time in Step S606.

After the process of Step S606 or S608 or in a case where the standby unit number acquired this time is the value N_{F} or more (NO route of Step S605), the macro accommodation checking unit 510 determines whether or not the macro accommodation one-second checking process has been completed for all the LUs in Step S607. In a case where the checking process has not been completed for all the LUs (NO route of Step S607), the macro accommodation checking unit 510 returns the process to Step S602. On the other hand, in a case where the checking process has been completed for all the LUs (YES route of Step S607), the macro accommodation checking unit 510 ends the macro accommodation one-second checking process.

By performing the macro accommodation one-second checking process as above every one second within one macro cycle (30 seconds), the value N_{E} that is finally stored in the QoS control area 213 becomes the minimum residual unit number N_{E} during one macro cycle. Similarly, the value N_{F} that is finally stored in the QoS control area 213 becomes the minimum standby unit number N_{F} during one macro cycle. Here, the process of Steps S603 and S604 and the process of Steps S605 and S606 may be performed in reverse order.

[2-7] Macro Accommodation Process

Next, the processing sequence of the macro accommodation process (Step S109 illustrated in FIG. 6) performed by the macro accommodation processing unit 520 according to this embodiment will be described along a flowchart (Steps S701 to S713) illustrated in FIGS. 14 and 15. The macro accommodation process is performed every one macro cycle (for example 30 seconds) after the QoS I/O startup scheduling process performed by the scheduling unit 506 while the N milli-second timer scheduling process illustrated in FIG. 6 is performed for every N milli-seconds. In the macro accommodation process, after the QoS I/O startup scheduling, at the timing for every one macro cycle, the macro bandwidth accommodation is performed from a LU continuously having room for the processing bandwidth to spare to a LU continuously having insufficiency of the processing bandwidth.

First, the first determination unit 521, for each LU, determines whether the minimum standby unit number N_{E} of the LU is a value other than zero, and the accommodation flag F_{INMAX} of the LU is Off in Step S701. Here, in a case where the minimum standby unit number N_{F} of the LU is a value other than zero, the LU is constantly in the standby state at the one-second notch timing in one macro cycle. Accordingly, the LU is regarded to be in the insufficient state of the processing bandwidth for one macro cycle, and, in this embodiment, and it is determined that the above-described “condition for receiving accommodation” is satisfied. However, in a case where the accommodation flag F_{INMAX} of the LU is On, the accommodation amount of the macro bandwidth accommodation received from the other LUs has arrived at the upper limit in the LU, and the macro bandwidth accommodation is not able to be performed. Thus, in this embodiment, for each LU, it is determined whether the minimum standby unit number N_{F} of the LU is a value other than zero, and the accommodation flag F_{INMAX} of the LU is Off.

In a case where the minimum standby unit number N_{F} of the LU is a value other than zero and the accommodation flag F_{INMAX} of the LU is Off (YES route of Step S701), the first determination unit 521 inserts the minimum standby unit number N_{F} of the target LU of this time into an appropriate position in the standby unit array aligned in order of greatest to least standby unit numbers in Step S702. The standby unit array for the macro bandwidth accommodation, for example, is generated inside the QoS control area 213 and stores the LUN specifying a LU and the minimum standby unit number N_{F} of the LU in association with each other. In this embodiment, the “accommodation LU number in one cycle” in the macro bandwidth accommodation, for example, is set to 4 LUs, and accordingly, four is sufficient as the number of elements of the standby unit array.

After the process of Step S702 or in a case where the minimum standby unit number N_{F} of the LU is zero, or the accommodation flag F_{INMAX} of the LU is On (NO route of Step S701), the first determination unit 521 determines whether or not the determination of the minimum standby unit number N_{F} has been performed for all the LUs in Step S703. In a case where the determination of a standby unit number has not been performed for all the LUs (NO route of Step S703), the first determination unit 521 returns the process to Step S701. On the other hand, in a case where the determination of a standby unit number has been performed for all the LUs (YES route of Step S703), the macro accommodation processing unit 520 determines whether or not a standby unit is present in the standby unit array for the macro bandwidth accommodation in Step S704. In a case where a standby unit is present in the standby unit array for the macro bandwidth accommodation (NO route of Step S704), the macro accommodation processing unit 520 completes the macro accommodation process.

On the other hand, in a case where a standby unit is present in the standby unit array for the macro bandwidth accommodation (YES route of Step S704), the second determination unit 522, for each LU, determines whether the minimum residual unit number N_{E} of the LU is a value other than zero, and the accommodation flag F_{OUTMAX} of the LU is Off in Step S705. Here, in a case where the minimum residual unit number N_{E} of the LU is a value other than zero, the LU is constantly in a residual state at the one-second notch timing in one macro cycle. Accordingly, the LU is regarded to be in a state in which there is room for the processing bandwidth to spare continuously in one macro cycle, and, in this embodiment, it is determined that the above-described “condition for accommodation” is satisfied. However, in a case where the accommodation flag F_{OUTMAX} of the LU is On, the accommodation amount of the macro bandwidth accommodation for another LU arrives at the lower limit in the LU, and the macro bandwidth accommodation is not able to be performed. Thus, in this embodiment, for each LU, it is determined whether the minimum residual unit number N_{E} of the LU is a value other than zero, and the accommodation flag F_{OUTMAX} of the LU is Off.

In a case where the minimum residual unit number N_{E} of the LU is a value other than zero, and the accommodation flag F_{OUTMAX} of the LU is Off (YES route of Step S705), the second determination unit 522 inserts the minimum residual unit number N_{E} of the target LU of this time into an appropriate position in the residual unit array aligned in order of greatest to least residual unit numbers in Step S706. The residual unit array for the macro bandwidth accommodation, for example, is generated inside the QoS control area 213 and stores the LUN specifying a LU and the minimum residual unit number N_{E} of the LU in association with each other. In this embodiment, the “accommodation LU number in one cycle” in the macro bandwidth accommodation, for example, is set to 4 LUs, and accordingly, four is sufficient as the number of elements of the standby unit array.

After the process of Step S706 or in a case where the minimum residual unit number N_{E} of the LU is zero, or the accommodation flag F_{OUTMAX} of the LU is On (NO route of Step S705), the second determination unit 522 determines whether or not the determination of the minimum residual unit number N_{E} has been performed for all the LUs in Step S707. In a case where the determination of a standby unit number has not been performed for all the LUs (NO route of Step S707), the second determination unit 522 returns the process to Step S705.

In a case where the determination of a standby unit number has been performed for all the LUs (YES route of Step S707), the macro accommodation processing unit 520 determines whether the element [i] of the standby unit array is zero or the element [i] of the residual unit array is zero in Step S708. In a case where the element [i] of the standby unit array is zero or the element [i] of the residual unit array is zero (YES route of Step S708), the macro accommodation processing unit 520 completes the macro accommodation process.

In a case where neither the element [i] of the standby unit array nor the element [i] of the residual unit array is not zero (NO route of Step S708), the macro accommodation processing unit 520 (change unit 523) performs the following process (Steps S709 to S713). Here, an accommodation destination LU relating to the i-th element [i] of the standby unit array and an accommodation source LU relating to the i-th element [i] of the residual unit array are set as one combination for which the macro bandwidth accommodation is performed. In this embodiment, since the number of elements of each array is four, for example, i is 0, 1, 2, or 3. The process of Steps S708 to S713 is performed in order of greatest to least standby unit numbers of residual unit numbers of each array.

Among the processes of Steps S709 to S713, the process of Step S709 is targeted for the QoS control area 213 of the accommodation destination LU. In addition, among the processes of Steps S709 to S713, the process of Steps S710 to S712 is targeted for the QoS control area 213 of the accommodation source LU.

The change unit 523 sets and changes the bandwidth accommodation information stored in the QoS control area 213 relating to the i-th accommodation destination LU of the standby unit array as below in Step S709. The change unit 523 sets the accommodation flag F_{IN} of the i-th accommodation destination LU to On. In addition, the change unit 523 increments the accommodation unit number N_{B} of the i-th accommodation destination LU by one. Accordingly, values (for example, 5 MB/s and 60 IOPS) corresponding to one unit are added to the bandwidth limits calculated for the accommodation destination LU (see Step S123 illustrated in FIG. 7). In addition, by incrementing the accommodation unit number N_{B} by one, in a case where an accommodation amount from another LU arrives at the upper limit, the change unit 523 sets the accommodation flag F_{INMAX} to On.

Then, the change unit 523 determines whether or not the accommodation flag F_{IN} of the i-th accommodation source LU of the residual unit array is On in Step S710. In a case where the accommodation flag F_{IN} is On (YES route of Step S710), it is assumed that the i-th accommodation source LU has room for the processing bandwidth to spare but receives bandwidth accommodation from another LU. Thus, the change unit 523 sets and changes the bandwidth accommodation information, which is stored in the QoS control area 213, relating to the i-th accommodation source LU of the residual unit array as below in Step S711.

The change unit 523 decreases the accommodation unit number N_{B} of the i-th accommodation source LU by one. Accordingly, values (for example, 5 MB/s and 60 IOPS) corresponding to one unit are subtracted from the bandwidth limits calculated for the accommodation source LU (see Step S123 illustrated in FIG. 7). In addition, in a case where the accommodation flag F_{INMAX} of the i-th accommodation source LU is On, in other words, in a case where the accommodation amount accommodated from another LU arrives at the upper limit, the change unit 523 sets the accommodation flag F_{INMAX} of the i-th accommodation source LU to Off. Furthermore, in a case where the accommodation unit number N_{B} becomes zero in accordance with the decreasing of the accommodation unit number N_{B} by one, the accommodation amount received by the i-th accommodation source LU from another LU is zero, and accordingly, the change unit 523 sets the accommodation flag F_{IN} of the i-th accommodation source LU to Off.

In a case where the accommodation flag F_{IN} of the i-th accommodation source LU is Off (NO route of Step S710), the change unit 523 sets and changes the bandwidth accommodation information, which is stored in the QoS control area 213, relating to i-th the accommodation source LU as below in Step S712. The change unit 523 sets the accommodation flag F_{OUT} of the i-th accommodation source LU to On. In addition, the change unit 523 increments the accommodation unit number N_{B} of the i-th accommodation source LU by one. Accordingly, values (for example, 5 MB/s and 60 IOPS) corresponding to one unit are subtracted from the bandwidth limits calculated for the accommodation source LU (see Step S125 illustrated in FIG. 7). Furthermore, in a case where the accommodation amount to another LU arrives at the upper limit in accordance with the incrementing of the accommodation unit number N_{B} by one, the change unit 523 sets the accommodation flag F_{OUTMAX} to On.

After the process of Step S711 or S712, the macro accommodation processing unit 520 determines whether or not a next element [i] is present in the standby unit array for the macro bandwidth accommodation in Step S713. In a case where the next element [i] is present (YES route of Step S713), the macro accommodation processing unit 520 returns the process to Step S708. On the other hand, in a case where the next element [i] is not present (NO route of Step S713), the macro accommodation processing unit 520 completes the macro accommodation process.

[2-8] Macro Accommodation Restoration Process

Next, the processing sequence of the macro accommodation restoration process (Step S107 illustrated in FIG. 6) performed by the restoration processing unit 532 according to this embodiment will be described along a flowchart (Steps S801 to S818) illustrated in FIGS. 16 and 17. In a case where bandwidth insufficiency of a LU accommodating the bandwidth to another LU (YES route of Step S106 illustrated in FIG. 6) while the N milli-second timer scheduling process illustrated in FIG. 6 is performed every N milli-seconds, the macro accommodation restoration process is performed for returning the bandwidth of the LU to the originally set bandwidth. In other words, in the macro accommodation restoration process, the processing amount accommodated by the accommodation restoration LU to another LU is returned from the accommodation destination LU to the accommodation restoration LU. At that time, the restoration processing unit 532 returns the processing amounts from the accommodation destination LUs to the accommodation restoration LU such that the residual amounts of the processing amounts accommodated to the accommodation destination LUs are uniform or approximately uniform.

The restoration processing unit 532, first, checks whether or not an accommodation restoration LU is present in Step S801. In a case where no accommodation restoration LU is not present (NO route of Step S801), the restoration processing unit 532 completes the macro accommodation restoration process.

On the other hand, in a case where an accommodation restoration LU is present (YES route of Step S801), the restoration processing unit 532, for each LU, performs the following process (Steps S802 to S805). The restoration processing unit 532 determines whether or not the accommodation flag F_{IN} of the target LU is On, in other words, whether or not the target LU is an accommodation destination LU in Step S802.

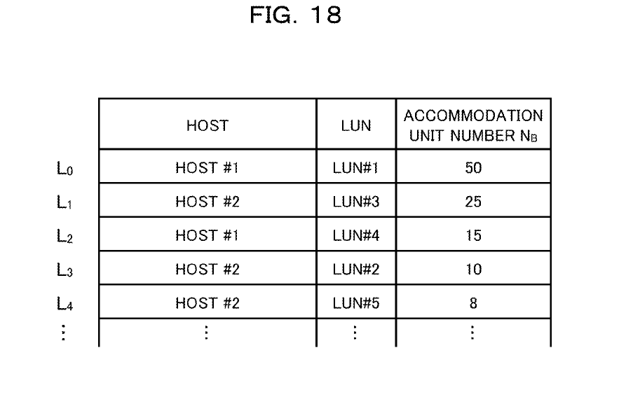

In a case where the target LU is an accommodation destination LU (YES route of Step S802), the restoration processing unit 532 inserts the accommodation unit number N_{B} of the target LU of this time into an appropriate position in the accommodation destination unit array aligned in order of greatest to least accommodation unit numbers N_{B} in Step S803. In addition, the restoration processing unit 532 also generates an array that associates the LUN specifying the accommodation destination LU and a number specifying the host relating to the accommodation destination LU with each other in Step S804. The accommodation destination unit array including a LU/host number array, for example, is generated inside the QoS control area 213 and stores the LUN specifying the accommodation destination LU and the accommodation unit number N_{B} of the LU in association with each other. An example of the accommodation destination unit array (LUN/host number array) will be described later with reference to FIG. 18. In addition, the number of elements of the accommodation destination unit array, for example, is 15. In a case where the target is “a combination of a port and a LUN”, the restoration processing unit 532, in Step S804, also generates an array associating the LUN specifying the accommodation destination LU and information specifying the port relating to the accommodation destination LU.

After the process of Step S804 or in a case where the target LU is not an accommodation destination LU (NO route of Step S802), the restoration processing unit 532 determines whether or not the determination of an accommodation flag F_{IN} has been performed for all the LUs in Step S805. In a case where the determination of an accommodation flag F_{IN} has not been performed for all the LUs (NO route of Step S805), the restoration processing unit 532 returns the process to Step S802. On the other hand, in a case where the determination of an accommodation flag F_{IN} has been performed for all the LUs (YES route of Step S805), the restoration processing unit 532 performs the following process (Steps S806 to S818) while referring to the accommodation destination unit array generated in Steps S803 and S804. Accordingly, the restoration processing unit 532 returns the processing amount from the accommodation destination LUs to the accommodation restoration LU such that the residual amounts of the processing amounts accommodated to the accommodation destination LUs are uniform or approximately uniform.

In performing the following process using the restoration processing unit 532, it is assumed that a unit number (the number of required units) to be recovered to the accommodation restoration LU is A, and the restoration remaining unit number is R. The initial value of the restoration residual unit number R is the required unit number A. In addition, the accommodation destination unit array number (the number of elements of the accommodation destination unit array) is set to M, inter-array unit numbers are set to X₀, X₁, X₂, . . . , X_{M-1} (here, X₀≧X₂≧X₂≧ . . . ≧X_{M-1}), and inter-array LUs are set to L₀, L₁, L₂, . . . , L_{M-1} in Step S806.

Then, the restoration processing unit 532, from i=0 in Step S807, determines whether or not the restoration residual unit number R is (Xᵢ−Xᵢ₊₁)×(i+1) or less in Step S808. In a case where the restoration residual unit number R is more than (Xᵢ−Xᵢ₊₁)×(i+1) (NO route of Step S808), the restoration processing unit 532 subtracts (Xᵢ−Xᵢ₊₁) from the accommodation unit numbers N_{B} from L₀ to Lᵢ of the LUs within the array in the QoS control area 213. At this time, in a case where the accommodation flag F_{INMAX} of each of L₀ to Lᵢ is On, the restoration processing unit 532 sets the accommodation flag F_{INMAX} to Off. Then, the restoration processing unit 532 replaces the restoration residual unit number R with R−(Xᵢ−Xᵢ₊₁)×(i+1) in Step S809. Thereafter, the restoration processing unit 532 increments i to i+1 in Step S810 and determines whether or not i coincides with M−1 in Step S811. In a case where i and M−1 do not coincide with each other (NO route of Step S811), the restoration processing unit 532 returns the process to Step S808.

On the other hand, in a case where the restoration residual unit number R is “(Xᵢ−Xᵢ₊ᵢ)×(i+1)” or less (YES route of Step S808), the restoration processing unit 532 performs the following process in Step S812. The restoration processing unit 532 divides the restoration residual unit number R into (i+1) or less integer values. Then, the restoration processing unit 532 subtracts integer values acquired through division from the accommodation unit number N_{B} of L₀ to Lᵢ of the LUs within the array in the QoS control area 213. At this time, in a case where the accommodation flag F_{INMAX} of each of L₀ to Lᵢ is On, the restoration processing unit 532 sets the accommodation flag F_{INMAX} to Off. Then, in a case where the accommodation unit number N_{B} becomes zero in accordance with the subtraction process of the accommodation unit number N_{B}, the restoration processing unit 532 sets the accommodation flag F_{IN} to Off. Then, the restoration processing unit 532 replaces the restoration residual unit number R with zero.

After the process of Step S812 or in a case where i coincides with M−1 (YES route of Step S811), the restoration processing unit 532 determines whether or not the restoration residual unit number R coincides with zero in Step S813. In a case where the restoration residual unit number R is not zero (NO route of Step S813), the restoration processing unit 532 selects a LU having a newest LUN among all the LUs of which the accommodation flags F_{IN} are On in Step S814. Thereafter, the restoration processing unit 532 determines whether or not the restoration residual unit number R is the accommodation unit number N_{B} of the selected LU or less in Step S815.

In a case where the restoration residual unit number R is more than the accommodation unit number N_{B} (NO route of Step S815), the restoration processing unit 532 replaces the restoration residual unit number R with a value acquired by subtracting the accommodation unit number N_{B} from R. In addition, the restoration processing unit 532 sets the accommodation unit number N_{B} of the selected LU to zero in the QoS control area 213. Furthermore, in a case where the accommodation flag F_{INMAX} of the selected LU is On, the restoration processing unit 532 sets the accommodation flag F_{INMAX} to Off. Then, the restoration processing unit 532 sets the accommodation flag F_{IN} to Off in Step S816.

After the process of Step S816, the restoration processing unit 532, returning the process to Step S814, selects a LU having a next newest LUN among all the LUs of which the accommodation flags F_{IN} are On and performs the same process (Steps S815 and S816).

On the other hand, in a case where the restoration residual unit number R is the accommodation unit number N_{B} or less (YES route of Step S815), the restoration processing unit 532 subtracts the restoration residual unit number R from the accommodation unit number N_{B} of the selected LU in the QoS control area 213. In addition, in a case where the accommodation flag F_{INMAX} of the selected LU is On, the restoration processing unit 532 sets the accommodation flag F_{INMAX} to Off. Furthermore, in a case where the accommodation unit number N_{B} becomes zero in accordance with the subtraction process of the accommodation unit number N_{B}, the restoration processing unit 532 sets the accommodation flag F_{IN} to Off. Then, the restoration processing unit 532 replaces the restoration residual unit number R with zero in Step S817.

After the process of Step S817 or in a case where the restoration residual unit number R is zero (YES route of Step S813), the restoration processing unit 532 sets both the accommodation flags F_{OUT} and F_{OUTMAX} of the accommodation restoration LU to Off in the QoS control area 213. In addition, the restoration processing unit 532 sets the accommodation unit number N_{B} of the accommodation restoration LU to zero in the QoS control area 213 in Step S818. Thereafter, the restoration processing unit 532 completes the macro accommodation restoration process.

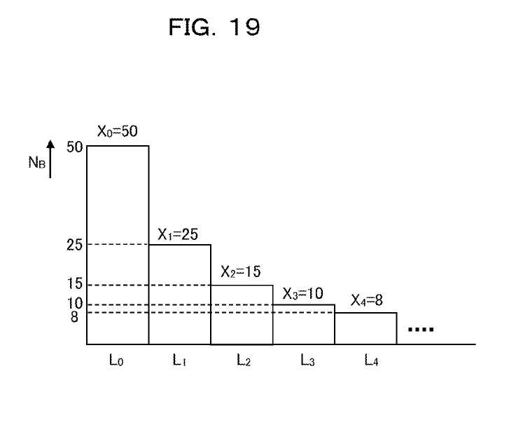

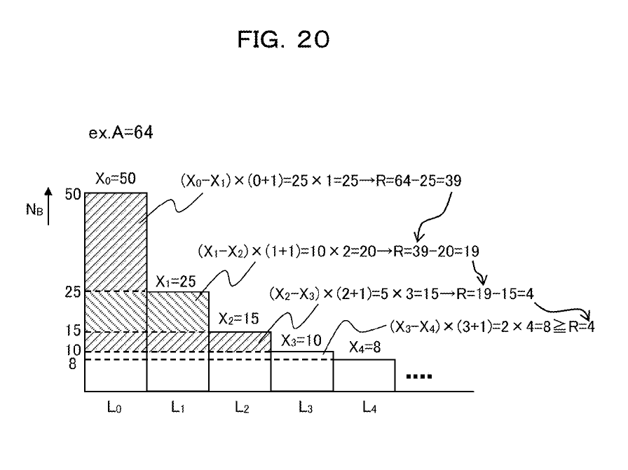

Next, the process of Steps S807 to S813 illustrated in FIG. 17 will be described more specifically with reference to an example illustrated in FIGS. 18 to 20. FIG. 18 is a diagram that illustrates an example of the accommodation destination unit array (LUN/host number array) generated in the macro accommodation restoration process (Steps S803 and S804 illustrated in FIG. 16) according to this embodiment. In addition, FIGS. 19 and 20 are diagrams that specifically illustrate the macro accommodation restoration process (particularly, Steps S807 to S813 illustrated in FIG. 17) according to this embodiment more specifically.

In the accommodation destination unit array illustrated in FIG. 18, a host number and a LUN specifying a “combination of a host and a LUN” and an accommodation unit number N_{B} of an accommodation destination LU corresponding to the LUN are associated with each other and are sorted in order of greatest to least accommodation unit numbers N_{B}. In the example illustrated in FIGS. 18 and 19, L₀ among the LUs within the array corresponds to host #1 and LUN #1, and the accommodation unit number N_{B} (=X₀) of L₀ is 50. In addition, Lᵢ among the LUs within the array corresponds to host #2 and LUN #3, and the accommodation unit number N_{B} (=X₁) of L₁ is 25, and L₂ among the LUs within the array corresponds to host #1 and LUN #4, and the accommodation unit number N_{B} (=X₂) of L₂ is 15. Furthermore, L₃ among the LUs within the array corresponds to host #2 and LUN #2, and the accommodation unit number N_{B} (=X₃) of L₃ is 10, and L₄ among the LUs within the array corresponds to host #2 and LUN #5, and the accommodation unit number N_{B} (=X₄) of L₄ is 8. Here, the accommodation destination unit array number (the number of elements of the accommodation destination unit array) M is assumed to be 10.

Hereinafter, based on the accommodation destination unit array illustrated in FIGS. 18 and 19, the processing sequence of a case where the restoration processing unit 532 recovers units corresponding to a required unit number A=64 to the accommodation restoration LU will be described more specifically. At this time, the initial value of the restoration residual unit number R is 64 that is the required unit number A. The restoration processing unit 532, after setting i=0 in Step S807, first, calculates the value (Xᵢ−Xᵢ₊₁)×(i+1)=(X₀−X₁)×(0+1)=25×1=25 at the time of i=0. Since the value of R is 64, R>25 (NO route of Step S808), and the restoration processing unit 532 subtracts 25 from the accommodation unit number N_{B} of L₀, so that the bandwidth corresponding to 25 units can be recovered to the accommodation restoration unit from L₀. Then, the restoration processing unit 532 changes the value of the restoration residual unit number R from 64 to “64−25”=39 (see Step S809; uppermost equation illustrated in FIG. 20).

Next, the restoration processing unit 532 increments i by one such that i=1 in Step S810. At this time, since i=1≠“M−1”=9 (NO route of Step S811), the restoration processing unit 532 returns the process to Step S808 and calculates the value (Xᵢ−Xᵢ₊₁)×(i+1)=(X₁−X₂)×(1+1)=10×2=20 at the time of i=1. Since the value of R is 39, R>20 (NO route of Step S808), and the restoration processing unit 532 subtracts 10 respectively from the accommodation unit numbers N_{B} of L₀ and L₁, so that the bandwidth corresponding to 20 units can be recovered to the accommodation restoration unit from L₀ and L₁. Then, the restoration processing unit 532 changes the value of the restoration residual unit number R from 39 to “39−20”=19 (see Step S809; second equation from the top in FIG. 20).

Next, the restoration processing unit 532 increments i by one such that i=2 in Step S810. At this time, since i=2≠“M−1”=9 (NO route of Step S811), the restoration processing unit 532 returns the process to Step S808 and calculates the value (Xᵢ−Xᵢ₊₁)×(i+1)=(X₂−X₃)×(2+1)=5×3=15 at the time of i=2. Since the value of R is 19, R>15 (NO route of Step S808), and the restoration processing unit 532 subtracts 5 respectively from the accommodation unit numbers N_{B} of L₀, L₁, and L₂, so that the bandwidth corresponding to 15 units can be recovered to the accommodation restoration unit from L₀, L₁, and L₂. Then, the restoration processing unit 532 changes the value of the restoration residual unit number R from 19 to “19−15”=4 (see Step S809; third equation from the top in FIG. 20).

Next, the restoration processing unit 532 increments i by one such that i=3 in Step S810. At this time, since i=3 # “M−1”=9 (NO route of Step S811), the restoration processing unit 532 returns the process to Step S808 and calculates the value (Xᵢ−Xᵢ₊₁)×(i+1)=(X₃−X₄)×(3+1)=2×4=8 at the time of i=3. Since the value of R is 4, R≦8 (YES route of Step S808; see fourth equation from the top in FIG. 20), and the restoration processing unit 532 divides the restoration residual unit number R=4 into (i+1)=4 or less integer values. Here, R=4 is divided into four LUs of L₀ to L₃, and the restoration processing unit 532 subtracts 1 respectively from the accommodation unit numbers N_{B} four LUs of L₀ to L₃ and changes the value of the restoration residual unit number R from 4 to 0 in Step S812. At this time, since R=0 (YES route of Step S813), the restoration processing unit 532 proceeds to the process of Step S818.

Through the above-described process, the bandwidth (processing amount) accommodated from the accommodation restoration LU to other LUs is recovered from the accommodation destination LU to the accommodation restoration LU. At that time, the bandwidth can be returned to the accommodation restoration LU from the accommodation destination LUs such that the residual amounts of the bandwidth (processing amount) accommodated to the accommodation destination LUs are uniform or approximately uniform.

[3] Advantages of this Embodiment

According to the storage apparatus 100 of this embodiment, by distributing the performance of the storage apparatus 100 in accordance with the performance level (the priority level) of a combination of a used host and a LU, the QoS function of the storage can be easily realized.

In addition, according to the storage apparatus 100 of this embodiment, the storage performance can be optimally controlled in accordance with the status of input/output requests (I/O requests or commands) from the host 10 or a change in the connection environment of the host 10. Particularly, in the macro bandwidth accommodation of this embodiment, the bandwidth accommodation is performed with minimum intervals of 5 MB/s and 60 IOPS of the bandwidth value with respect to the priority level being used as “one unit”. Accordingly, the change interval (accommodation amount) of the bandwidth limit can be configured to be markedly smaller than that of a case where the bandwidth limit is changed by changing the priority level, and a change in the processing bandwidth requested from the host 10 can be delicately followed, whereby various performance changes can be responded. At that time, since the bandwidth is accommodated from a LU having room for the processing bandwidth to spare to a LU having bandwidth insufficiency among a plurality of volumes (LUs), the bandwidth accommodation can be reliably performed.

Furthermore, in the storage apparatus 100 of this embodiment, based on the characteristics of the micro bandwidth accommodation and the macro bandwidth accommodation, any one of the micro bandwidth accommodation and the macro bandwidth accommodation is used. In a case where any one of the micro bandwidth accommodation and the macro bandwidth accommodation is used, appropriate bandwidth accommodation can be selected in accordance with the operating environment using the storage QoS of the storage apparatus 100. In addition, in a case where both thereof are used, by performing control such that the micro bandwidth accommodation is used for absorbing a temporary spike performance and the like, and the macro bandwidth accommodation is used for absorbing continuous performance variations, the characteristics of both thereof can be effectively utilized.

In addition, in the micro bandwidth accommodation of this embodiment, the processing bandwidth is accommodated to a LU having processing bandwidth insufficiency from a LU having room for the processing bandwidth to spare at a micro cycle, for example, of one second or less. The accommodation amount at that time is neither stored nor reflected on the adjustment of the bandwidth limit at the next micro cycle. Accordingly, the storage apparatus 100 operates with the original processing bandwidth at the next micro cycle. In this way, since the micro bandwidth accommodation is temporary accommodation, by using the micro bandwidth accommodation, a large amount of bandwidth accommodation can be performed at a time.

Particularly, in the micro bandwidth accommodation according to this embodiment, in a case where an accommodation destination LU (standby LU) is present, it is determined whether or not there is a bandwidth to spare in the RAID group including the standby LU based on the busy rate L. In a case where there is no bandwidth to spare, even when there is an accommodation source LU (residual LU), the micro bandwidth accommodation is not performed. In this way, it can be avoided that a bandwidth to spare of the whole RAID group disappears according to the bandwidth accommodation from the residual LU to the standby LU.

In addition, in the micro bandwidth accommodation according to this embodiment, when there is no LU having a processing bandwidth to spare, and accommodation of the processing bandwidth to the accommodation destination LU is not performed, it is checked whether or not there is a bandwidth to spare in the RAID group to which the accommodation destination LU belongs. Then, in a case where there is a bandwidth to spare, as illustrated in FIG. 11, micro bandwidth accommodation from an unassigned band other than the LU band (QoS setting band) of the RAID group can be performed. Accordingly, a LU having an insufficient bandwidth can be resolved by effectively using the unassigned band of the RAID group without causing bandwidth insufficiency.

Furthermore, in the micro bandwidth accommodation according to this embodiment, when the bandwidth accommodation to the accommodation destination LU is performed, the bandwidth accommodation is performed while an increment relating to an increase in the busy rate L according to the amount of the bandwidth accommodation is calculated by the busy rate calculating unit 545. In addition, in a case where a plurality of accommodation destination LUs are present, for example, the bandwidth accommodation is performed in order of highest to lowest number of standby units. At that time, by reflecting the busy rate increment after the bandwidth accommodation on the busy rate L, the execution of the bandwidth accommodation causing the busy rate L to exceed far over the predetermined threshold is reliably suppressed.

Furthermore, in the macro bandwidth accommodation of this embodiment, the processing bandwidth is monitored at a longer macro cycle, for example, of two seconds or more. Then, the processing bandwidth is accommodated to a LU having bandwidth insufficiency continuously for a predetermined time (for example, one macro cycle) from a LU having room for the processing bandwidth to spare continuously for the predetermined time. In this way, since the bandwidth accommodation amount is adjusted through learning in the macro bandwidth accommodation, continuous variations in the processing bandwidth requested from the host 10 can be effectively responded.

In addition, according to the storage apparatus 100 of this embodiment, in a case where the insufficiency in the processing bandwidth occurs in the accommodation source LU, in other words, in a case where an accommodation restoration LU is present, the bandwidth (processing amount) accommodated from the accommodation restoration LU to other LUs is returned from the accommodation destination LU to the accommodation restoration LU. At that time, the bandwidth can be returned from the accommodation destination LUs to the accommodation restoration LU such that the residual amounts of the bandwidth (processing amounts) accommodated to the accommodation destination LUs are uniform or approximately uniform. In other words, the accommodation amounts in a plurality of accommodation destination LUs after the bandwidth restoration of the accommodation restoration LU can be configured to remain uniformly or approximately uniformly, whereby a deviation of the accommodation amounts in the plurality of accommodation destination LUs disappears. Accordingly, in the storage apparatus 100 including the plurality of accommodation destination LUs, subsequent processes can be effectively performed.

[4] Others

While the preferred embodiment of the present invention has been described in detail, the present invention is not limited to the embodiment described above, but various changes and modifications can be made therein in a range not departing from the concept of the present invention.

In addition, each constituent unit illustrated in the figure is a functional and conceptual unit and thus, is not necessarily required to be physically configured as illustrated in the figures. For example, in the SCSI target control unit 303, the command reception unit 504 and the scheduling unit 506 may be integrated together. In addition, the whole or an arbitrary part of each processing function performed in each device may be realized by a CPU and a program that is interpreted and executed by the CPU or may be realized by hardware using wired logic.

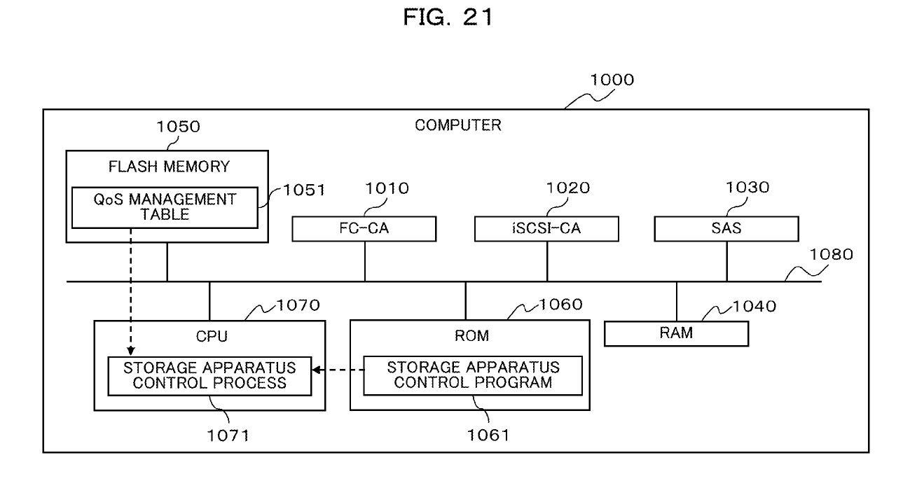

Furthermore, various processes described in this embodiment may be realized by executing a program prepared in advance using a computer included in the storage apparatus. Thus, hereinafter, an example of a computer executing a storage apparatus control program having the same function as this embodiment will be described with reference to FIG. 21. FIG. 21 is a block diagram that illustrates a computer executing the storage apparatus control program according to this embodiment.

As illustrated in FIG. 21, the computer 1000 includes an FC-CA 1010 that is an interface for a host, an iSCSI-CA 1020 that is an interface for a host, and an SAS 1030 that is an interface for a disk device. In addition, the computer 1000 includes a RAM 1040 that temporarily stores various kinds of information and a rewritable non-volatile flash memory 1050 in which data does not disappear even when the power is turned off. Furthermore, the computer 1000 includes a read only memory (ROM) 1060 that is a reading-dedicated memory and a CPU 1070 that performs various calculation processes. Here, the units included in the computer 1000 are interconnected through a bus 1080.

In the flash memory 1050, a QoS management table 1051 corresponding to the QoS management table 501 illustrated in FIGS. 3 and 5, the bandwidth accommodation information of each LU illustrated in FIG. 3, and the like are stored. In addition, in the ROM 1060, a storage apparatus control program 1061 having functions similar to those of the calculation unit 505, the scheduling unit 506, the execution unit 507, the macro accommodation checking unit 510, the macro accommodation processing unit 520, the macro accommodation restoration processing unit 530, and the micro accommodation processing unit 540 illustrated in FIG. 3 is stored.

Then, the CPU 1070 executes the storage apparatus control program 1061 read from the ROM 1060 as a storage apparatus control process 1071 by referring to the QoS management table 1051 or the bandwidth accommodation information of each LU read from the flash memory 1050.

In addition, the above-described storage apparatus control program 1061 is not necessarily required to be stored in the ROM 1060. For example, the storage apparatus control program 1061 may be provided in a form being recorded in a computer-readable recording medium such as a flexible disk, a CD (a CD-ROM, a CD-R, a CD-RW, or the like), a DVD (a DVD-ROM, a DVD-RAM, a DVD-R, a DVD-RW, a DVD+R, a DVD+RW, or the like), or a Blue-ray disc. In such a case, the computer 1000 reads the storage apparatus control program 1061 from the recording medium and transmits the program to an internal storage device or an external storage device so as to be stored therein and used. Furthermore, this storage apparatus control program 1061 may be stored in another computer (or a server) connected to the computer 1000 through a public line, the Internet, a local area network (LAN), a wide area network (WAN), or the like, and the storage apparatus control program 1061 may be configured to be read therefrom and executed by the computer 1000.

According to one embodiment, a bandwidth to spare of a storage apparatus to which a storage device belongs can be accommodated to a storage device having an insufficient bandwidth.

All examples and conditional language provided herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A storage apparatus comprising a processor:
the processor
determines presence/absence of an input/output request that is in a standby state for each of a plurality of storage devices;
determines presence/absence of a bandwidth to spare of the storage apparatus including the plurality of storage devices in a case where a first storage device, for which the input/output request that is in the standby state, is determined to be present among the plurality of storage devices; and
executes bandwidth accommodation from a first unassigned band of the storage apparatus to the first storage device in a case where the bandwidth to spare is determined to be present in the storage apparatus.

2. The storage apparatus according to claim 1, wherein, in a case where a second storage device having the bandwidth to spare is not present in the plurality of storage devices, the processor executes the bandwidth accommodation from a second unassigned band other than a band of the storage apparatus that is used for the plurality of storage devices to the first storage device.

3. The storage apparatus according to claim 1, wherein, in a case where a second storage device having the bandwidth to spare is present in the plurality of storage devices, the processor executes the bandwidth accommodation from a third unassigned band in a band used for the second storage device to the first storage device.

4. The storage apparatus according to claim 1, wherein the processor calculates a busy rate (hereinafter, referred to as a RAID group busy rate) of a RAID (Redundant Arrays of Inexpensive Disks) group, to which the plurality of storage devices belong, of the storage apparatus,
in a case where the calculated RAID group busy rate is less than a predetermined value, the processor determines that the bandwidth to spare is present in the storage apparatus.

5. The storage apparatus according to claim 4, wherein the processor calculates the busy rate of each of a plurality of disk drives included in the RAID group and calculates an average busy rate of the plurality of disk drives as the RAID group busy rate.

6. The storage apparatus according to claim 5, wherein, in a case where disk drives of mutually-different types are included in the plurality of disk drives, the processor calculates the RAID group busy rate by multiplying the busy rate of each disk drive by a coefficient according to each of the types.

7. The storage apparatus according to claim 5, wherein, in a case where a plurality of the RAID groups configure an automatic hierarchization pool, the processor calculates the RAID group busy rate of the plurality of the RAID groups by multiplying each of a plurality of the RAID group busy rates calculated for the plurality of the RAID groups by a weighting coefficient according to the type of each disk drive included in each RAID group.

8. The storage apparatus according to claim 4, wherein the processor converts a bandwidth accommodation amount for the first storage device into a busy rate increment and uses a value, acquired by adding the converted busy rate increment to the RAID group busy rate, as the RAID group busy rate after the bandwidth accommodation.

9. A method of controlling a storage apparatus,
determining presence/absence of an input/output request that is in a standby state for each of a plurality of storage devices;
determining presence/absence of a bandwidth to spare of the storage apparatus including the plurality of storage devices in a case where a first storage device, for which the input/output request that is in the standby state, is determined to be present among the plurality of storage devices; and
executing bandwidth accommodation from a first unassigned band of the storage apparatus to the first storage device in a case where the bandwidth to spare is determined to be present in the storage apparatus.

10. The method according to claim 9, further comprising executing, in a case where a second storage device having the bandwidth to spare is not present in the plurality of storage devices, the bandwidth accommodation from a second unassigned band other than a band of the storage apparatus that is used for the plurality of storage devices to the first storage device.

11. The method according to claim 9, further comprising executing, in a case where a second storage device having the bandwidth to spare is present in the plurality of storage devices, the bandwidth accommodation from a third unassigned band in a band used for the second storage device to the accommodation destination storage device.

12. The method according to claim 9, further comprising:
calculating a busy rate (hereinafter, referred to as a RAID group busy rate) of a RAID (Redundant Arrays of Inexpensive Disks) group, to which the plurality of storage devices belong, of the storage apparatus by using the storage apparatus; and
determining that the bandwidth to spare is present in the storage apparatus in a case where the calculated RAID group busy rate is less than a predetermined value.

13. The method according to claim 12, further comprising: calculating the busy rate of each of a plurality of disk drives included in the RAID group and calculating an average busy rate of the plurality of disk drives as the RAID group busy rate.

14. The method according to claim 12, further comprising: converting a bandwidth accommodation amount for the first storage device into a busy rate increment and using a value, acquired by adding the converted busy rate increment to the RAID group busy rate, as the RAID group busy rate after the bandwidth accommodation.

15. A non-transitory computer-readable recording medium having a storage apparatus control program stored thereon, the storage apparatus control program causes a computer included in a storage apparatus to execute:
determining presence/absence of an input/output request that is in a standby state for each of a plurality of storage devices;
determining presence/absence of a bandwidth to spare of the storage apparatus including the plurality of storage devices in a case where a first storage device, for which the input/output request that is in the standby state, is determined to be present among the plurality of storage devices; and
executing bandwidth accommodation from a first unassigned band of the storage apparatus to the first storage device in a case where the bandwidth to spare is determined to be present in the storage apparatus.

16. The non-transitory computer-readable recording medium according to claim 15, wherein the storage apparatus control program causes the computer to further execute: executing, in a case where a second storage device having the bandwidth to spare is not present in the plurality of storage devices, the bandwidth accommodation from a second unassigned band other than a band of the storage apparatus that is used for the plurality of storage devices to the first storage device.

17. The non-transitory computer-readable recording medium according to claim 15, wherein the storage apparatus control program causes the computer to further execute: executing, in a case where a second storage device having the bandwidth to spare is present in the plurality of storage devices, the bandwidth accommodation from a third unassigned band in a band used for the second storage device to the first storage device.

18. The non-transitory computer-readable recording medium according to claim 15, wherein the storage apparatus control program causes the computer to further execute:
calculating a busy rate (hereinafter, referred to as a RAID group busy rate) of a RAID (Redundant Arrays of Inexpensive Disks) group, to which the plurality of storage devices belong, of the storage apparatus; and
determining that the bandwidth to spare is present in the storage apparatus in a case where the calculated RAID group busy rate is less than a predetermined value.

19. The non-transitory computer-readable recording medium according to claim 18, wherein the storage apparatus control program causes the computer to further execute: calculating the busy rate of each of a plurality of disk drives included in the RAID group and calculating an average busy rate of the plurality of disk drives as the RAID group busy rate.

20. The non-transitory computer-readable recording medium according to claim 18, wherein the storage apparatus control program causes the computer to further execute: converting a bandwidth accommodation amount for the first storage device into a busy rate increment and using a value, acquired by adding the converted busy rate increment to the RAID group busy rate, as the RAID group busy rate after the bandwidth accommodation.
